(19) United States
(12) Patent Application Publication
(10) Pub. No.: US 2026/0086313 A1
(43) Pub. Date: Mar. 26, 2026

(54) SYSTEMS AND METHODS FOR PHOTONIC INTERCONNECTION

(71) Applicants: The MITRE Corporation, McLean, VA (US); Massachusetts Institute of Technology, Cambridge, MA (US)

(72) Inventors: Matthew SAHA, Bedford, MA (US); Dirk Robert ENGLUND, Cambridge, MA (US); Genevieve CLARK, McLean, VA (US)

(73) Assignees: The MITRE Corporation, McLean, VA (US); Massachusetts Institute of Technology, Cambridge, MA (US)

(21) Appl. No.: 19/340,671

(22) Filed: Sep. 25, 2025

Related U.S. Application Data
(60) Provisional application No. 63/698,910, filed on Sep. 25, 2024.

(51) Int. Cl. G02B 6/44; G02B 6/26; G02B 6/293; G02B 6/42

(52) U.S. Cl. CPC G02B 6/448; G02B 6/262; G02B 6/29326; G02B 6/2934; G02B 6/4214; G02B 6/4239; G02B 6/4244

(57) ABSTRACT

A photonic system is provided. The photonic system comprises a first photonic component and a second photonic component. The photonic system additionally comprises a photonic ribbon cable comprising a waveguide extending from a first end of the photonic ribbon cable to a second end of the photonic ribbon cable and having a winding geometry configured to deform, enabling the first end of the photonic ribbon cable to be extended away from the second end of the photonic ribbon cable. The first end of the photonic ribbon cable is optically coupled to the first photonic component and the second end of the waveguide is optically coupled to the second photonic component.

### CROSS-REFERENCE TO RELATED APPLICATIONS

This application claims the benefit of U.S. Provisional Application No. 63/698,910, filed Sep. 25, 2024, the entire contents of which is incorporated herein by reference.

### FIELD

The present disclosure relates generally to photonic integrated circuits, in particular to devices for optically interconnecting photonic integrated circuits.

### BACKGROUND

Despite the remarkable development in photonics throughout the past few decades, optical packaging remains as an ever-present obstacle for large-scale implementations of photonics-integrated systems. Particularly when designing photonic systems at scale, there are numerous requirements optical interconnects must meet. Though some of these requirements are specific to particular photonic platforms and applications, considerations broadly include optical transmission efficiency, alignment tolerances, device footprint, fabrication complexity and scalability, mechanical resilience, and stability in expected thermal conditions.

### SUMMARY

Disclosed are extendable optical interconnects that can be used to optically couple spatially separated photonic components. The winding geometry of these flexible, micron-to meter-scale, extendable optical interconnects (referred to herein as “photonic ribbon cables” (PRCs)) are both mechanically resilient and optically efficient, thereby allowing PRCs to be used to connect optical components that are separated by relatively short or relatively large distances and/or to connect out-of-plane components at scale.

A PRC can be fabricated using standard wafer or semiconductor (e.g., CMOS) fabrication techniques. The PRC itself can comprise a waveguide that has a winding shape. During fabrication, the PRC can be formed on a layer of sacrificial material. At least a portion of this sacrificial layer can be removed, undercutting at least a portion of the winding shape. This enables a first end of the waveguide to be extended away from a second end of the waveguide. The PRC can then be used to optically interconnect photonic components that are separated, such as photonic components on a photonic integrated circuit that has been divided in two, or photonic components on two different photonic integrated circuits.

PRCs can be used to optically interconnect optical systems with complex connection geometries and requirements. Unlike other optical interconnects such as fiber optic cables, PRCs are fundamentally scalable at the wafer-level and beyond due to their size, channel density, and design flexibility regarding materials, waveguide dimensions, guided modes, and optical coupling interfaces. As a result, PRCs can facilitate the creation of more compact systems with significantly smaller footprints than the footprints of systems that utilize, e.g., fiber optic cables. Moreover, a single PRC can include multiple waveguide channels and can be used to optically interconnect a large number of photonic components. PRCs can also be configured to function as electrical interconnects and may therefore facilitate the creation of large-scale optoelectronic systems (e.g., quantum computing systems) that are both cost-and space-efficient by reducing the number of necessary interconnection components.

According to an aspect, a photonic ribbon cable may include a waveguide having a winding geometry that enables a first end of the waveguide to be extended away from a second end of the waveguide.

In any of these embodiments, the photonic ribbon cable may be manufactured using a semiconductor device fabrication process. In any of these embodiments, the first end of the waveguide may be extendable away from the second end of the waveguide within a first plane. In any of these embodiments, the first end of the waveguide may be extendable from a first plane containing the second end of the waveguide into a second plane that is different from the first plane. In any of these embodiments, the waveguide comprises a plurality of bends. In any of these embodiments, the plurality of bends may include at least one bend with a horseshoe shape. In any of these embodiments, the waveguide may include a plurality of linear segments of the same length connected by the plurality of bends. In any of these embodiments, the plurality of bends may form concentric spirals. In any of these embodiments, the first end of the waveguide may include a bond pad. In any of these embodiments, the second end of the waveguide may include a bond pad. In any of these embodiments, the photonic ribbon cable may include a cladding material that encases the waveguide. In any of these embodiments, the waveguide may include two or more waveguide channels. In any of these embodiments, the photonic ribbon cable may include an electrical conductor, wherein the electrical conductor is layered with the waveguide and has the same winding geometry as the waveguide, wherein the winding geometry enables a first end of the electrical conductor to be extended away from a second end of the electrical conductor.

According to an aspect, a photonic system includes a first photonic component; a second photonic component; and a photonic ribbon cable comprising a waveguide extending from a first end of the photonic ribbon cable to a second end of the photonic ribbon cable and having a winding geometry that enables the first end of the photonic ribbon cable to be extended away from the second end of the photonic ribbon cable, wherein the first end of the photonic ribbon cable is optically coupled to the first photonic component and the second end of the waveguide is optically coupled to the second photonic component. In any of these embodiments, the first photonic component and the second photonic component may be positioned in the same plane. In any of these embodiments, the first photonic component may be positioned in a first plane and the second photonic component may be positioned in a second plane different from the first plane. In any of these embodiments, the first photonic component may be a component of a first chip and the second photonic component may be a component of a second chip. In any of these embodiments, the first chip and the second chip may be formed by cleaving a third chip in two. In any of these embodiments, the photonic ribbon cable may be fabricated on the third chip using a semiconductor device fabrication process, wherein, during fabrication, a medial portion of the waveguide between the first end of the waveguide and the second end of the waveguide was released from the third chip. In any of these embodiments, the photonic ribbon cable was fabricated on the first chip using a semiconductor device fabrication process, wherein, during fabrication, the second end of the waveguide was released from the first chip. In any of these embodiments, a separation distance between the first photonic component and the second photonic component may be at least 10 cm. In any of these embodiments, the separation distance may be at least 1 m. In any of these embodiments, the first photonic component may be located in a cryogenic environment and the second photonic component may be located in a room temperature environment. In any of these embodiments, the first photonic component may be optically sensitive and the second photonic component may be optically noisy. In any of these embodiments, the system may be a quantum computing system.

According to an aspect, a method for optically interconnecting photonic devices includes forming a waveguide on a chip, the waveguide having a winding geometry; undercutting at least a portion of the waveguide by removing a sacrificial material underlying the at least a portion of the waveguide; and optically coupling a first photonic component to a second photonic component using the waveguide, wherein optically coupling the first photonic component to the second photonic component comprises moving ends of the waveguide away from each other. In any of these embodiments, the first photonic component and the second photonic component may be components of the chip, wherein moving the ends of the waveguide away from each other may include cleaving the chip without cleaving the waveguide to form a first chip comprising the first photonic component and a second chip comprising the second photonic component, wherein the waveguide bridges the first chip and the second chip. In any of these embodiments, the chip may be a first chip, wherein the first photonic component may be a component of the first chip, wherein the second photonic component may be a component of a second chip, wherein optically coupling the first photonic component to the second photonic component may include lifting a first end of the waveguide from the first chip; and placing the first end of the waveguide on the second chip. In any of these embodiments, undercutting at least a portion of the waveguide may include undercutting the entire waveguide. In any of these embodiments, the chip may be a first chip, wherein the first photonic component may be a component of a second chip, wherein the second photonic component may be a component of a third chip, wherein optically coupling the first photonic component to the second photonic component may include lifting the waveguide from the first chip; placing a first end of the waveguide on the second chip; and placing a second end of the waveguide on the third chip.

In some embodiments, a photonic ribbon cable is provided, the photonic ribbon cable comprising: a waveguide having a winding geometry that enables the waveguide to deform such that a first end of the waveguide extends away from a second end of the waveguide.

In some embodiments, the photonic ribbon cable was manufactured using a semiconductor device fabrication process. In some embodiments, the first end of the waveguide is extendable away from the second end of the waveguide within a first plane. In some embodiments, the first end of the waveguide is extendable from a first plane containing the second end of the waveguide into a second plane that is different from the first plane. In some embodiments, the waveguide comprises a plurality of bends. In some embodiments, the plurality of bends comprises at least one bend with a horseshoe shape. In some embodiments, the photonic ribbon cable further comprises one or more tethers formed at one or more of the plurality of bends, wherein the one or more tethers are configured to constrain movement of the photonic ribbon cable prior to extension. In some embodiments, the waveguide is deformable from a first unextended position to a second extended position; in the first unextended position, a bend of the plurality of bends has a first radius of curvature; and in the second extended position, the bend of the plurality of bends has a second radius of curvature greater than the first radius of curvature. In some embodiments, the plurality of bends form concentric spirals. In some embodiments, the waveguide comprises a plurality of linear segments of the same length connected by the plurality of bends. In some embodiments, the waveguide is deformable from a first unextended position to a second extended position; the waveguide has a rectangular cross section; in the first unextended position, the plurality of bends and the plurality of linear segments have a zero-roll flat orientation with respect to a direction of propagation of light within the waveguide; and in the second extended position, a bend of the plurality of bends has a non-zero-roll banked orientation and a linear segment of the plurality of linear segments has a twisting-roll orientation.

In some embodiments, the first end of the waveguide comprises a bond pad. In some embodiments, the second end of the waveguide comprises a bond pads. In some embodiments, the first end of the waveguide comprises a first bond pad and the second end of the waveguide comprises a second bond pad. In some embodiments, the photonic ribbon cable further comprises a cladding material that encases the waveguide. In some embodiments, the waveguide comprises silicon and the cladding comprises silicon dioxide. In some embodiments, the waveguide comprises silicon nitride and the cladding comprises silicon dioxide. In some embodiments, the waveguide comprises silicon or silicon nitride and the cladding comprises silicon dioxide. In some embodiments, the waveguide comprises two or more waveguide channels. In some embodiments, different waveguide channels of the two or more waveguide channels are configured to transmit different optical wavelengths. In some embodiments, at least two of the two or more waveguide channels comprise different cross-sectional widths. In some embodiments, one or more bond pads, at one or both of the first end of the waveguide and the second end of the waveguide, comprise one or more alignment features. In some embodiments, the waveguide comprises a taper region configured to adiabatically couple light between the waveguide and a target photonic component. In some embodiments, the taper region is configured to enlarge an optical mode of light within the waveguide. In some embodiments, the waveguide comprises a taper region configured to: adiabatically couple light between the waveguide and a target photonic component; and enlarge an optical mode of light within the waveguide. In some embodiments, the waveguide comprises a region configured to evanescently couple light between the waveguide and a target photonic component. In some embodiments, the waveguide comprises a region configured to couple light directly between a facet of the waveguide and a facet of a waveguide of a target photonic component. In some embodiments, at least one end of the waveguide terminates in a grating coupler configured to couple to a target photonic component. In some embodiments, at least one reflector, configured to improve coupling efficiency, is positioned above or below the grating coupler.

In some embodiments, the photonic ribbon cable further comprises: an electrical conductor, wherein the electrical conductor is layered with the waveguide and has the same winding geometry as the waveguide, wherein the winding geometry enables a first end of the electrical conductor to be extended away from a second end of the electrical conductor. In some embodiments, the electrical conductor comprises one or more metal layers within a cladding material and is configured to provide electrical interconnects between the photonic ribbon cable and one or more external electronic components. In some embodiments, the photonic ribbon cable further comprises at least one piezoelectric layer within a cladding material, the piezoelectric layer configured to actuate mechanical deformation of the photonic ribbon cable. In some embodiments, the electrical conductor comprises a plurality of metal layers and the at least one piezoelectric layer is disposed between the plurality of metal layers. In some embodiments, the photonic ribbon cable further comprises at least one piezoelectric layer within a cladding material, wherein: the at least one piezoelectric layer is configured to actuate mechanical deformation of the photonic ribbon cable, the electrical conductor comprises a plurality of metal layers, and the at least one piezoelectric layer is disposed between the plurality of metal layers.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

This application contains at least one drawing executed in color. Copies of this patent application publication with color drawing(s) will be provided by the Office upon request and payment of the necessary fee.

The following figures show various photonic ribbon cables (PRCs) and systems comprising PRCs. The devices and systems shown in the figures may have any one or more of the characteristics described herein.

FIG. 1A shows a cross-sectional view of a PRC system prior to the release of the PRC from the underlying photonic integrated circuit, according to some embodiments.

FIG. 1B shows a cross-sectional view of a PRC system following the release of the PRC from the underlying photonic integrated circuit, according to some embodiments.

FIG. 1C shows a cross-sectional view of a PRC system with multiple waveguide channels, according to some embodiments.

FIG. 2A shows a top-down view of a PRC system comprising a PRC configured for in-plane extension, according to some embodiments.

FIG. 2B shows a perspective view of a PRC that is configured for in-plane extension in a collapsed state, according to some embodiments.

FIG. 2C shows a perspective view of a PRC that is configured for in-plane extension in an extended state, according to some embodiments.

FIG. 2D shows an example scanning electron microscope (SEM) image of a curved segment of a PRC that is configured for in-plane extension, according to some embodiments.

FIG. 2E shows another example SEM image of a curved segment of a PRC that is configured for in-plane extension, according to some embodiments.

FIG. 2F shows another example SEM image of a curved segment a PRC that is configured for in-plane extension, according to some embodiments.

FIG. 2G shows another example SEM image of a curved segment a PRC that is configured for in-plane extension, according to some embodiments.

FIG. 3A shows a PRC connecting divided portions of a single photonic integrated circuit, according to some embodiments.

FIG. 3B shows a SEM image of a PRC connecting divided portions of a single photonic integrated circuit, according to some embodiments.

FIG. 3C shows light transmitting through a PRC between divided portions of a single photonic integrated circuit, according to some embodiments.

FIG. 4A shows a SEM image of a PRC with a single fixed end, according to some embodiments.

FIG. 4B shows a close-up view of a bond pad on a releasable end of a PRC with a single fixed end, according to some embodiments.

FIG. 4C shows a schematic of pick-and-place attachment of a released end of a PRC from a parent photonic integrated circuit to a target photonic integrated circuit, according to some embodiments.

FIG. 4D shows a close-up view of a releasable end of a PRC that does not include a bond pad, according to some embodiments.

FIG. 4E shows a schematic of an example bonding process for bonding a released end of a PRC to a target photonic integrated circuit, according to some embodiments.

FIG. 4F shows a schematic of another example bonding process for bonding a released end of a PRC to a target photonic integrated circuit, according to some embodiments.

FIG. 4G shows a schematic of another example bonding process for bonding a released end of a PRC to a target photonic integrated circuit, according to some embodiments.

FIG. 4H shows a breakable tether design for securing PRCs in place after undercutting, according to some embodiments.

FIG. 4I shows a breakable tether design for securing PRCs in place after undercutting, according to some embodiments.

FIG. 4J shows a breakable tether design for securing PRCs in place after undercutting, according to some embodiments.

FIG. 4K shows a PRC with multiple waveguides organized into mini-cables, according to some embodiments.

FIG. 4L shows a PRC with waveguides of different widths for optimized propagation, according to some embodiments.

FIG. 5A shows a PRC with no fixed ends, according to some embodiments.

FIG. 5B shows a schematic of pick-and-place attachment of the released ends of a PRC to connect two target photonic integrated circuits, according to some embodiments.

FIG. 6A shows a top-down view of a PRC that is configured for out-of-plane extension, according to some embodiments.

FIG. 6B shows a side view of a PRC that is configured for out-of-plane extension in an extended state, according to some embodiments.

FIG. 6C shows a top-down view of another PRC that is configured for out-of-plane extension, according to some embodiments.

FIG. 6D shows a SEM image of a PRC that is configured for out-of-plane extension, according to some embodiments.

FIG. 7A shows a schematic of an example optical coupling interface between a PRC and a target photonic integrated circuit, according to some embodiments.

FIG. 7B shows a perspective view of a finite element method (FEM) optical coupling simulation of a coupling interface between a PRC and a target photonic integrated circuit, according to some embodiments.

FIG. 7C shows a schematic of another example optical coupling interface between a PRC and a target photonic integrated circuit, according to some embodiments.

FIG. 7D shows a top-down view of a finite element method (FEM) optical coupling simulation of a coupling interface between a PRC and a target photonic integrated circuit, according to some embodiments.

FIG. 7E shows a PRC with a two-stage taper for adiabatic coupling, according to some embodiments.

FIG. 7F shows a PRC with a tapered cladding region for vertical mode expansion, according to some embodiments.

FIG. 7G shows an evanescent coupling interface between a PRC and a target photonic integrated circuit, according to some embodiments.

FIG. 8A shows a schematic of another example optical coupling interface between a PRC and a target photonic integrated circuit, according to some embodiments.

FIG. 8B shows a schematic of another example optical coupling interface between a PRC and a target photonic integrated circuit, according to some embodiments.

FIG. 9A shows a PRC system comprising a PRC configured to function as an electrical interconnect prior to the release of the PRC from the underlying photonic integrated circuit, according to some embodiments. The PRC may include embedded conductors and a piezoelectric layer between electrodes for actuation.

FIG. 9B shows a PRC system comprising a PRC configured to function as an electrical interconnect following the release of the PRC from the underlying photonic integrated circuit, according to some embodiments. After release, the PRC may maintain electrical connectivity and be piezoelectrically actuated for controlled deformation or phase shifting.

FIG. 9C shows a PRC including optical waveguides and embedded metal lines for electrical interconnection, according to some embodiments.

FIG. 9D shows a PRC composed of four mini-cables, each including a waveguide and a metal line, according to some embodiments.

FIG. 9E shows a bonding method for electrically connecting PRC pads to receiving pads, according to some embodiments.

FIG. 9F shows a bonding method for electrically connecting PRC pads to receiving pads, according to some embodiments.

FIG. 9G shows a bonding method for electrically connecting PRC pads to receiving pads, according to some embodiments.

FIG. 10A shows a schematic of a quantum computing system that utilizes PRCs to interconnect a thermally sensitive photonic component, an optically sensitive photonic component, and a heat-generating optoelectronic component.

FIG. 10B shows a modular and hybrid photonic integrated circuit system interconnected with PRCs, according to some embodiments.

FIG. 11A shows a four-channel PRC with a grating coupler terminating each channel, according to some embodiments.

FIG. 11B shows a close-up view of an end portion of a grating-terminated PRC, according to some embodiments.

FIG. 11C shows components of a focusing grating coupler, according to some embodiments.

FIG. 11D shows optical outputs from a grating-terminated PRC, according to some embodiments.

FIG. 12A shows a PRC comprising a terminal ring resonator, according to some embodiments.

FIG. 12B shows a close-up view of an end portion of a ring-resonator-terminated PRC, according to some embodiments.

FIG. 13A shows a PRC with varying waveguide cross-sections along straight segments and bends, according to some embodiments.

FIG. 13B shows a PRC including bond pads for mechanical robustness, alignment, and/or socket latching, according to some embodiments.

FIG. 13C shows a PRC including bond pads for mechanical robustness, alignment, and/or socket latching, according to some embodiments.

FIG. 13D shows a PRC including bond pads for mechanical robustness, alignment, and/or socket latching, according to some embodiments.

FIG. 13E shows a PRC including bond pads for mechanical robustness, alignment, and/or socket latching, according to some embodiments.

FIG. 13F shows a PRC including bond pads for mechanical robustness, alignment, and/or socket latching, according to some embodiments.

FIG. 14A shows a PRC with grating couplers and optional reflectors for optical coupling, according to some embodiments.

FIG. 14B shows a PRC with grating couplers and optional reflectors for optical coupling, according to some embodiments.

FIG. 15 shows PRCs with an accordion-style meandering length using bend angles larger than 90° and 180°, according to some embodiments.

### DETAILED DESCRIPTION

Disclosed are extendable optical interconnects, referred to herein as “photonic ribbon cables,” that can be used to optically couple spatially separated photonic components. A photonic ribbon cable (PRC) can be fabricated on a chip, e.g., using a wafer/semiconductor fabrication process, and can comprise a released waveguide, or waveguides, having an extendable winding geometry, similar to a ribbon cable. During fabrication, the waveguide can be deposited and shaped atop a layer of sacrificial material that is later etched away to undercut at least a portion of the waveguide, thereby releasing that portion from any underlying chip layers and yielding the photonic ribbon cable.

The winding geometry of the waveguide augments the PRC's mechanical resiliency and can allow a first end of the PRC to be extended away from a second end of the PRC (that is, allows the PRC to be stretched). Additionally, the winding geometry of the waveguide ensures that, when the PRC is extended, light can be efficiently transmitted through the waveguide. A PRC can therefore be used to optically connect components that are separated by short or relatively large distances. In some embodiments, this is accomplished by optically coupling a first end of the PRC waveguide to a first optical component (e.g., an optical component of a first photonic integrated circuit (PIC)), extending the first end of the PRC away from the second end of the PRC, and optically coupling a second end of the PRC to a second optical component (e.g., an optical component of a second PIC).

The particular winding pattern of a PRC waveguide can determine the direction in which the PRC can be extended. Some winding patterns promote in-plane extension—that is, facilitate the extending of a first end of the PRC away from a second end of the PRC within (approximately) the same plane. A PRC fabricated with an “accordion” geometry wherein the waveguide comprises a series of longer, straight segments connected by shorter, curved segments, for example, may be optimized for in-plane extension. Other winding patterns promote out-of-plane extension, i.e., allow a first end of the PRC to be extended into a plane that is different from the plane in which the second end of the PRC lies. A PRC configured for out-of-plane extension may be fabricated with, e.g., an “apple-peel” or “paperclip” geometry wherein the waveguide follows a concentric spiral pattern. Accordingly, PRCs can be used to optically connect optical components that are spatially separated within the same plane or to optically connect optical components that are spatially separated within different planes.

Relative to circular optical cables, the flat, ribbon-like geometry of a PRC may provide additional opportunities for shaping the guided optical mode. For example, the lateral extent of the ribbon can be tailored to support broader or more asymmetric mode profiles, which may facilitate, for example, coupling to planar photonic components. This contrasts with circular cables, which may constrain the optical mode to a rotationally symmetric profile.

As a result of their ability to interconnect components both in-plane and out-of-plane that are separated by large distances, PRCs can be used to construct photonic and optoelectronic system with sensitive regions that require spatial isolation from noisy regions of the system to be optically interconnected with other regions of the system. For example, a PRC can enable an optically noisy region of a photonic system to be connected an optically sensitive region of a photonic system without the noisy region interfering with the sensitive region. Similarly, thermally sensitive region of the PIC to be thermally isolated from the region(s) of the PIC that require(s) or generate(s) heat. This enables sensitive regions of photonic systems to be isolated as needed, thus enhancing the performance of the photonic systems.

PRCs are also highly scalable. A single PRC can include multiple waveguide channels and, as a result, can be used to optically interconnect a large number of photonic components. Accordingly, the footprints of devices that utilize PRCs may be significantly smaller than the footprints of devices that utilize other optical interconnects (e.g., fiber optic cables). PRCs can also be configured to function as electrical interconnects and may therefore facilitate the creation of large-scale optoelectronic systems (e.g., quantum computing systems) that are both cost- and space-efficient by reducing the number of necessary interconnection components.

The provided PRCs can be utilized in a variety of photonic systems. Example photonic systems in which PRCs can be used include (but are not limited to) quantum computing systems, light detection and ranging (LiDAR) systems, optical sensing systems, and/or photonic computing systems. In some embodiments, PRCs can be used in a photonic system including one or more of the following components: a dynamic random-access memory (DRAM), a central processing unit (CPU), a wavelength-division multiplexing (WDM), laser, a photodetector, a reconfigurable optical add/drop multiplexer (ROADM), a transmitter, a receiver, and/or a transceiver.

The following description is presented to enable a person of ordinary skill in the art to make and use the various embodiments and aspects thereof disclosed herein. Descriptions of specific devices, assemblies, techniques, and applications are provided only as examples. Various modifications to the examples described herein will be readily apparent to those of ordinary skill in the art, and the general principles described herein may be applied to other examples and applications without departing from the spirit and scope of the various embodiments and aspects thereof. Thus, the various embodiments and aspects thereof are not intended to be limited to the examples described herein and shown but are to be accorded the scope consistent with the claims.

Any of the systems, methods, techniques, and/or features disclosed herein may be combined, in whole or in part, with any other systems, methods, techniques, and/or features disclosed herein.

Reference to “about” or “approximately” a value or parameter herein includes (and describes) variations of that value or parameter per se. For example, description referring to “approximately X”or “about X”includes description of “X”as well as variations of “X”.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

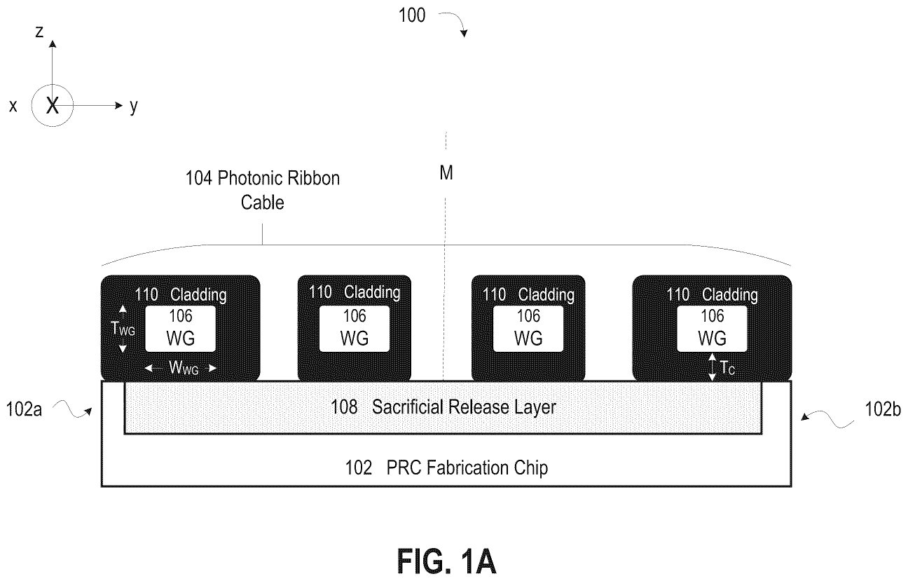

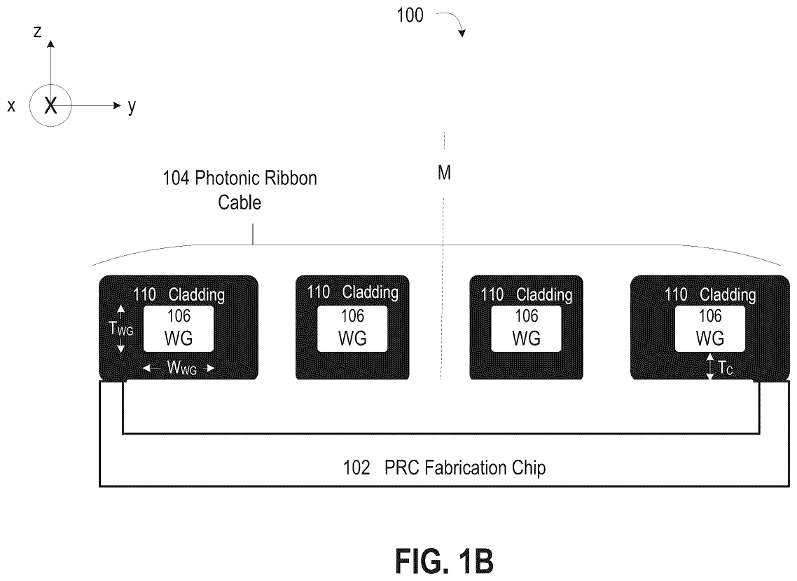

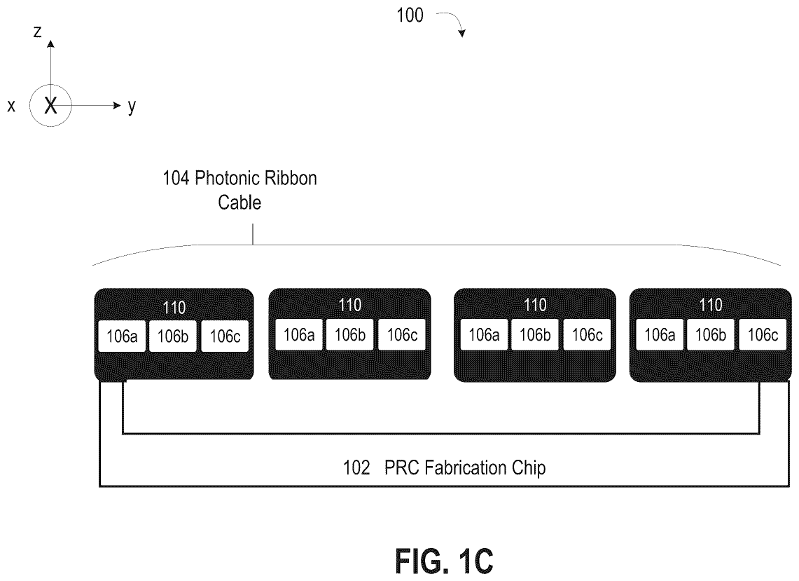

A cross-sectional side view of an exemplary photonic ribbon cable (PRC) system 100 used to fabricate a PRC is provided in FIGS. 1A-1B. Specifically, FIG. 1A shows an intermediate step in the fabrication of a PRC, and FIG. 1B shows an example final step in the fabrication of a PRC.

PRC system 100 can include a fabrication chip 102 comprising a photonic ribbon cable 104 disposed at least partially on a surface of a sacrificial release layer 108. PRC 104 comprises a micro-scale or nano-scale waveguide (WG) 106 having a winding geometry—that is, when viewed from above, one or more portions of waveguide 106 may curve, turn, bend, spiral, or zig-zag on the surface of chip 102 and sacrificial release layer 108. For example, as illustrated in FIGS. 1A-1B, between a first side 102a of chip 102 and a second side 102b of chip 102, waveguide 106 can repeatedly extend laterally across chip 102 (e.g., in the +x direction indicated in FIGS. 1A-1B), curve 180-degrees, and then extend laterally across chip 102 in the opposite direction (e.g., in the −x direction indicated in FIGS. 1A-1B). In some embodiments, the PRC 104 can be formed directly on the fabrication chip 102 itself.

Chip 102 can be any chip formed via a semiconductor fabrication process. For example, chip 102 can be a semiconductor wafer. In some embodiments, chip 102 can be a photonic integrated circuit (PIC), e.g., a photonic circuit on a semiconductor wafer. In some embodiments, chip 102 is only a fabrication platform for PRC 104; that is, PRC 104 may be configured to be completely removed from chip 102, and chip 102 may be discarded. In other embodiments, chip 102 comprises components other than PRC 104, for example other optical components (e.g., other waveguides) to which one or more ends of waveguide 106 are connected. In these embodiments, at least a portion of chip 102 may be retained, and PRC 104 may be configured to remain partially attached to the retained portion of chip 102 (e.g., attached at one end or at both ends).

In some embodiments, as shown in FIG. 1C, PRC 104 can include multiple adjacent waveguide channels 106a-106c. Channels 106a-106c can be joined to form a single cable that follows a winding or meandering pattern across the surface of sacrificial release layer 108 or directly on the fabrication chip 102. Channels 106a-106c can be joined at one end of PRC 104, at both ends of PRC 104, or along the entire length of PRC 104. While FIG. 1C depicts PRC 104 as including three waveguide channels, in various embodiments, PRC 104 includes between 2 and 100, between 2 and 50, between 2 and 25, between 2 and 15, or between 2 and 10 waveguide channels, for example 5 waveguide channels, 6 waveguide channels, 7 waveguide channels, 8 waveguide channels, or 9 waveguide channels. In other embodiments, waveguide 104 includes greater than 100 waveguide channels. PRC 104 can include a cladding 110 that encases waveguide 106. If PRC 104 includes multiple waveguide channels, each waveguide channel may be encased in cladding 110.

In some embodiments, if a PRC includes multiple waveguide channels, individual channels can be separated across the meandering length of the PRC. In other embodiments, individual channels are fully joined (e.g., with SiO₂ cladding) throughout the entire meandering length of the PRC. In embodiments wherein the individual channels are fully joined, all waveguide channels may be fully connected and may not be separable at any point. In some embodiments, the individual waveguide channels are connected only at one or both ends of the meandering length of the PRC. If the channels are only joined together on one side, each channel can be positioned independently to connect to different locations on a target chip. These individual channels may be more mechanically compliant than the PRC as a whole. In other embodiments, for increased manageability, the individual waveguide channels are connected at both ends, and the PRC comprises thin tethers configured to connect the channels to a target chip throughout the meandering length of the PRC.

Sacrificial release layer 108 can be removed using any suitable removal technique, e.g., through a chemical etching process configured to dissolve sacrificial release layer 108 without damaging the other components of PRC system 100. Removing sacrificial release layer 108 may release and freely suspend the portion of PRC 104 that was disposed on the surface of sacrificial release layer 108. FIG. 1A shows PRC system 100 prior to the removal of sacrificial release layer 108; FIG. 1B shows PRC system 100 after the removal of sacrificial release layer 108. In embodiments in which the PRC 104 is formed directly on the fabrication chip 102, one or more portions of the fabrication chip 102 are removed to release the portion of PRC 104.

In some implementations, fabrication of an exemplary PRC may include depositing a cladding layer on a waveguide layer, forming one or more trenches through the cladding and waveguide layers in the shape of a winding geometry to expose an underlying sacrificial layer, and removing at least a portion of the sacrificial layer through the trenches to undercut the waveguide. The removal may be performed by a dry etch process, such as etching with xenon difluoride, or by a reactive ion etch process. In some implementations, the waveguide may be formed with a plurality of bends including at least one horseshoe shape, and tethers may be incorporated at the bends to constrain movement of the PRC prior to extension. One or both ends of the waveguide may be fabricated to terminate in a grating coupler, and at least one reflector may be positioned above or below the grating coupler to improve coupling efficiency. This trench-based fabrication process may be integrated with the deposition of electrical metal layers or piezoelectric layers within the cladding to form an electrically actuated PRC as described in further detail herein.

In one or more embodiments, a medial portion of PRC 104 (e.g., a portion of PRC 104 proximal to a midline M of chip 102) is released upon removal of sacrificial release layer 108, while the lateral or end portions (e.g., portions of PRC 104 that are distal to the midline M of chip 102) of PRC 104 remain fixed to chip 102. In other embodiments, a medial portion of PRC 104 and one lateral or end portion of PRC 104 are released upon removal of sacrificial release layer 108, while the other lateral or end portion of PRC 104 remains fixed to chip 102. In other embodiments, the entirety of PRC 104 is released from chip 102.

Due to its winding geometry, PRC 104 can be stretched or extended in one or more directions relative to chip 102 following its release without its optical properties becoming compromised. PRC 104 can therefore be used to optically couple photonic components that are spatially separated by large distances (e.g., to optically couple components on two separate photonic chips) or photonic components positioned in different planes (e.g., to optically couple an on-chip component to an off-chip component positioned above the chip). This may facilitate the construction of three-dimensional optical systems as well as optical systems with spatially isolated sub-systems (for example, optical systems with components that require a precisely controlled environment).

In some implementations, the winding geometry of a PRC can impart a spring-like restoring force. When the PRC is extended, the straight and/or curved segments elastically deform and/or twist which, upon release of external force, allow the PRC to return to its default, compressed configuration. Such elasticity may improve handling robustness and enable repeatable extension and retraction cycles without permanent deformation.

Waveguide 106 can be formed from any suitable waveguide material. Example materials include (but are not limited to) silicon (Si), silicon nitride (SiN), GaAs, InGaAsP, and/or InP.

Waveguide 106 can have any suitable cross-sectional shape. For example, as shown in FIG. 1, waveguide 106 can have a rectangular cross-section. Alternatively, waveguide 106 can have a circular cross-section, an elliptical cross-section, and/or a rectangular/trapezoidal cross-section (e.g., waveguide 106 can be a “strip” waveguide). In some embodiments, waveguide 106 has a “U”-shaped cross-section. In other embodiments, waveguide 106 has a “H”-shaped cross-section. In some embodiments, waveguide 106 may form a rib (i.e., “ridge”), slab, or slot waveguide. In some embodiments, waveguide 106 may be a subwavelength waveguide comprising a cross-sectional shape that varies along the length of waveguide 106.

A cross-sectional width W_{WG} of waveguide 106 (or, more generally, if the cross-sectional shape of waveguide 104 is not rectangular, a size of waveguide 106 in along a first dimension, labeled y in FIG. 1) can be approximately nano-to micro-scale.

A cross-sectional thickness T_{WG} of waveguide 106 (or, more generally, if the cross-sectional shape of waveguide 104 is not rectangular, a size of waveguide 106 along a second dimension perpendicular to the first dimension, labeled z in FIG. 1) can be approximately nano-to micro-scale.

Sacrificial release layer 108 can be formed from any suitable sacrificial material, e.g., any material that can be removed following deposition through thermal, electrical, chemical, or mechanical processes without damaging the other components of chip 102. For example, sacrificial release layer 108 can be formed from a material that can be etched using xenon difluoride. Example materials include (but are not limited to) silicon (Si), amorphous silicon (a-SI), molybdenum, and/or germanium. In some embodiments, no sacrificial release layer deposition may be required as the fabrication substrate itself, optionally composed of silicon, can be selectively etched away using similar or identical processes (e.g. xenon difluoride etching).

Cladding 110 can be formed from any suitable material with a lower refractive index than the material from which waveguide 106 is formed (to facilitate propagation of light through waveguide 106). Example materials include (but are not limited to) silicon dioxide (SiO₂). The cladding material may be planarized to a target thickness by chemical mechanical polishing (CMP) to control confinement of the optical mode. A first cladding layer may be deposited on a semiconductor substrate, planarized to a target thickness using CMP, followed by deposition of a waveguide layer and deposition of a second cladding layer that is again planarized. The waveguide may include a silicon layer of a silicon-on-oxide substrate, and the winding geometry of the waveguide layer may be defined by patterning the waveguide layer using electron-beam lithography. The process used to fabricate an exemplary PRC may include at least one technique selected from material deposition, dry etching, reactive ion etching, and electron-beam lithography. Following fabrication, the PRC may be thermally annealed to, for example, decrease surface roughness and/or reduce optical losses.

In some implementations, a PRC may be fabricated such that the waveguide material itself constitutes substantially the entire cross-section of the cable, with air serving as the surrounding cladding medium. This configuration may simplify fabrication by reducing deposition of a separate cladding layer while maintaining sufficient index contrast for optical confinement (e.g., contrast of the relatively high refractive index of the waveguide and the lower refractive index of the surrounding air, thereby creating conditions for total internal reflection and guided mode propagation). Such an air-clad implementation may reduce overall device mass, which may be beneficial for suspended or tethered photonic applications.

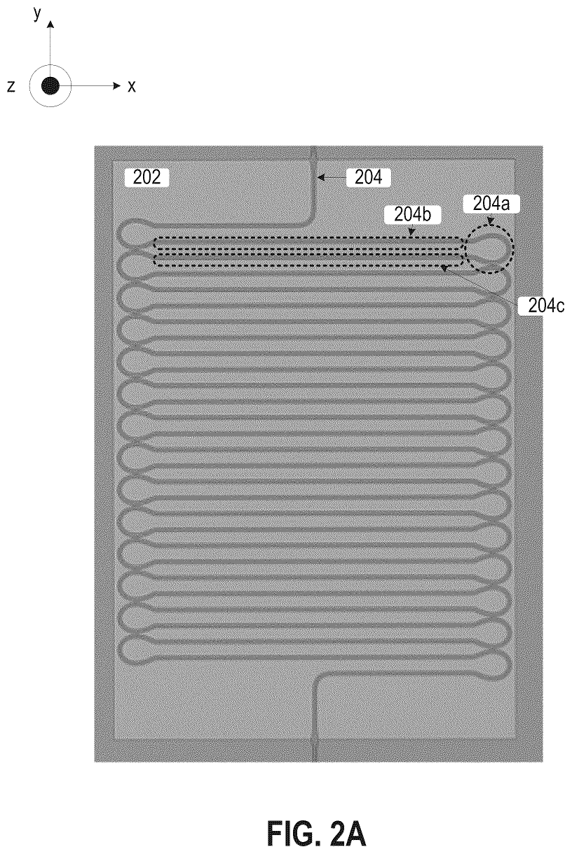

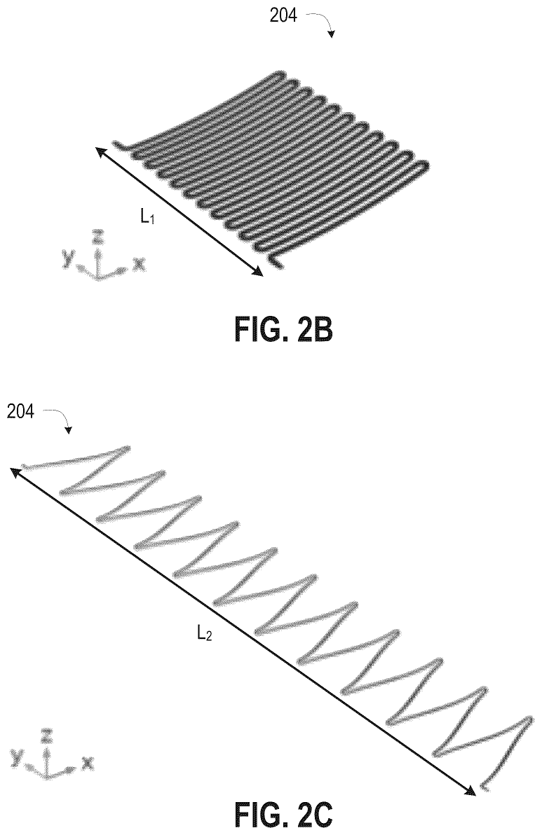

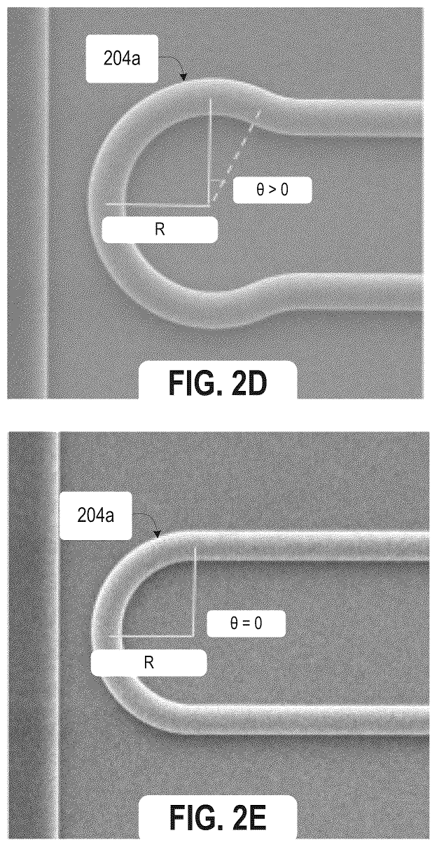

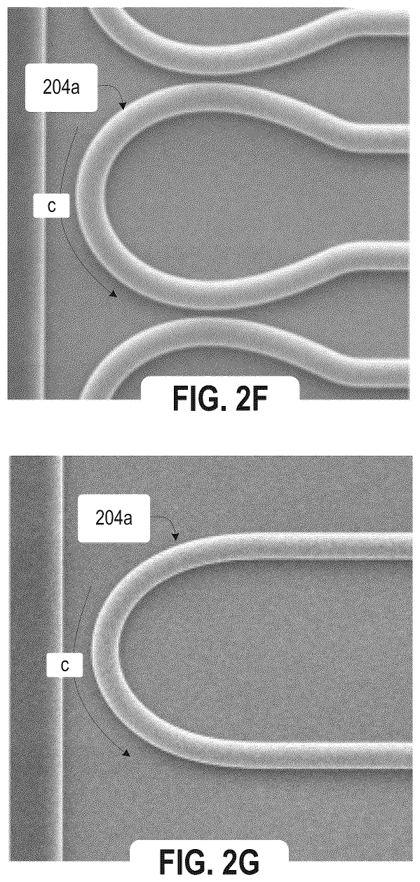

Some PRCs can be optimized for in-plane extension. Various views of an exemplary PRC 204 that is useful for in-plane extension are shown in FIGS. 2A-2G. PRC 204 can be formed on a chip 202 and can include a series of linear segments (e.g., segments 204b, 204c of PRC 204 shown in FIG. 2A) that extend across the surface of PIC 202 (e.g., in the x dimension indicated in FIGS. 2A-2C) connected by curved segments (e.g., segment 204a shown in FIGS. 2A, 2D-2G). This “accordion” geometry can allow PRC 204 to be stretched within the plane in which it was fabricated (e.g., in the x-y plane indicated in FIGS. 2A-2C) in a direction perpendicular to the direction of the linear segments (e.g., segments 204b, 204c shown in FIG. 2A) when PRC 204 is not extended (e.g., in the y direction indicated in FIGS. 2A-2C).

In some implementations, when PRC 204 is extended, the geometry of the curved portions may cause them to angle upward or downward relative to the fabrication plane, similar to a banked turn. At the same time, the linear segments may undergo axial twisting as strain redistributes along the cable. These deformations may occur while maintaining optical mode confinement, thereby enabling stable light transmission even as the PRC transitions between its compressed and extended states.

When fully extended, PRC 204 can be micron-to meter-scale in length, that is, a difference in a length L₁ of PRC 204 when PRC 204 is fully compressed (as shown in FIG. 2B) and a length L₂ of waveguide 204 when PRC 204 is fully extended (as shown in FIG. 2C) can be less than about 1 micron, between about 1 micron and about 1 m, or greater than about 1 m. In some embodiments, a difference between a length L₁ of PRC 204 when PRC 204 is fully compressed (as shown in FIG. 2B) and a length L₂ of waveguide 204 when PRC 204 is fully extended (as shown in FIG. 2C) can be at least 10 mm, at least 50 mm, at least 1 cm, at least 50 cm, or at least 100 cm. In some embodiments, a length L₁ of PRC 204 when PRC 204 is fully compressed (as shown in FIG. 2B) and a length L₂ of waveguide 204 when PRC 204 is fully extended (as shown in FIG. 2C) is greater than or equal to 1 m. In some embodiments, a length L₁ of PRC 204 when PRC 204 is fully compressed (as shown in FIG. 2B) and a length L₂ of waveguide 204 when PRC 204 is fully extended (as shown in FIG. 2C) is less than 1 mm.

The curved segments of PRC 204 can be configured to minimize both mechanical stress and optical losses. In some embodiments, a curved segment 204a of PRC 204 has a “horseshoe” shape that bulges outward relative to the linear segments it connects (FIG. 2D). In other embodiments, a curved segment 204a of PRC 204 forms a circular 180-degree arc (FIG. 2E). In other embodiments, a curved segment 204a of PRC 204 forms an Euler bend—that is, curved segment 204a has a curvature that changes approximately linearly along the direction of bending c (FIGS. 2F-2G). The Euler bend can be formed with a “horseshoe” shape (FIG. 2F) or without a “horseshoe”shape (FIG. 2G).

The geometry of PRC 204 may include multiple linear segments of the same length that are connected by a plurality of bends. At least one bend may comprise a horseshoe shape, and tethers may be formed at one or more of the bends to constrain movement of the PRC prior to extension. The waveguide may be deformable from a first unextended position to a second extended position such that, in the first unextended position, a bend has a first radius of curvature and, in the second extended position, the bend has a second radius of curvature greater than the first radius of curvature. In some implementations, in the first unextended position the plurality of bends and the plurality of linear segments may have a zero-roll flat orientation with respect to the direction of propagation of light (e.g., the segments lie flat within the fabrication plane without roll about their longitudinal axes). When extended, a bend can adopt a non-zero-roll banked orientation (e.g., the bend tilts upward or downward relative to the plane, similar to a banked curve in a roadway). Additionally or alternatively, a linear segment can assume a twisting-roll orientation (e.g., the linear segment undergoes torsional rotation along its longitudinal axis) while still maintaining confinement of the guided optical mode.

The optical and mechanical properties of curved segment 204a can vary depending on the radius R of curved segment 204a. In some embodiments, the radius R of curved segment 204a is between 10 μm and 50 μm, between 15 μm and 45 μm, between 20 μm and 40 μm, between 20 μm and 35 μm, or between 20 μm and 30 μm. For example, R of curved segment 204a may be approximately 21 μm, 22 μm, 23 μm, 24 μm, 25 μm, 26 μm, 27 μm, 28 μm, or 29 μm. In other embodiments, the radius R of curved segment 204a is less than 10 μm or greater than 50 μm. The radius R of curved segment 204a can be chosen based on the intended application of PRC 204 and, in various embodiments, can vary based on optical factors such as the wavelength of light that PRC 204 is designed to transmit and/or tolerances for optical loss.

The optical and mechanical properties of curved segment 204a can also depend on the angle θ between the line from the center of the curve to the point where the waveguide begins to curve and the line from the center of the curve to the point where the curve reaches its maximum radius. In some embodiments, θ=0°, in which case curved segment 204a forms a circular 180-degree arc (FIG. 2E). In other embodiments, θ>0°, in which case curved segment 204a forms a “horseshoe” shape (FIG. 2D). A curved segment 204a with a “horseshoe” can have a θ value between 1° and 45°, between 5° and 40°, between 10° and 35°, between 15° and 30°, or between 20° and 30°, for example approximately 22°, 25°, 27°, or 29°.

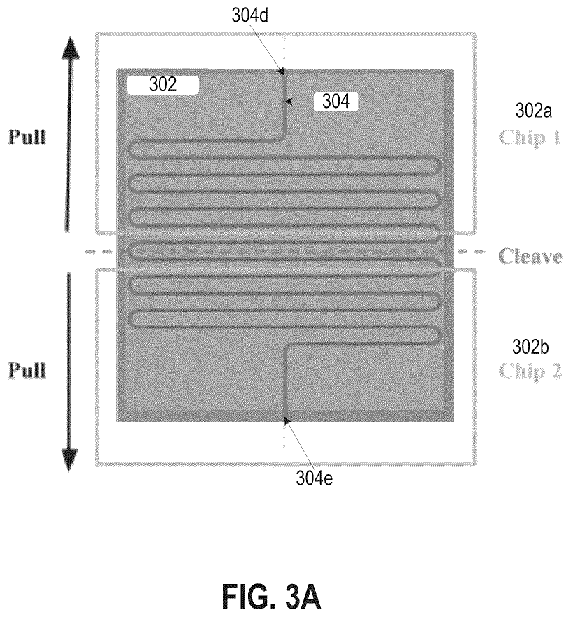

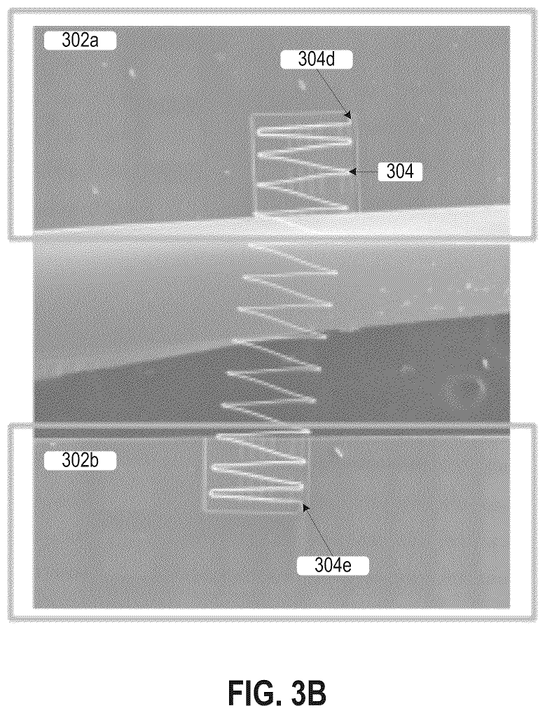

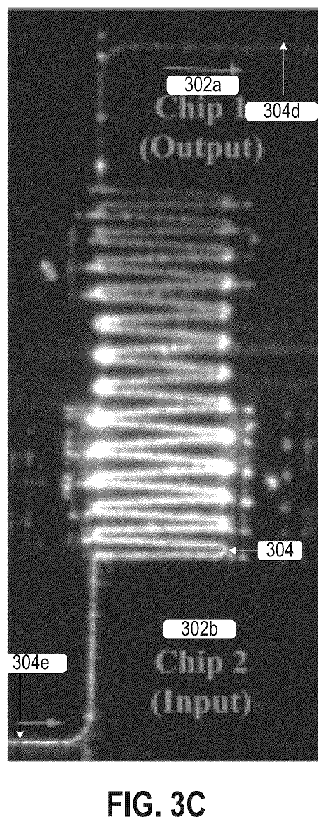

A chip (e.g., a photonic integrated circuit) that is fabricated with a PRC (e.g., chip 202) can be divided into multiple, optically interconnected chips by undercutting a medial region of the PRC while leaving the ends of the PRC anchored to the chip and then cleaving the chip in two beneath the undercut region of the PRC. For example, as shown in FIGS. 3A-3C, a PRC 304 with an “accordion” geometry can be formed on a photonic integrated circuit (PIC) 302. After PRC 304 is released, the medial portion of PRC 304 may be freely suspended above PIC 302, while both ends 304d-304e of PRC 304 remain anchored to PIC 302. PIC 302 can be cleaved into a first PIC 302a and a second PIC 302b beneath the released medial portion of PRC 304 (that is, PIC 302 can be cleaved while PRC 304 is not cleaved). First PIC 302a and second PIC 302b can then be pulled apart. PRC 304 is connected at a first end 304d to first PIC 302a and at a second end 304e to second PIC 302b, bridging the gap between PIC 302a and 302b. First PIC 302a and second PIC 302b can be shifted relative to one another while remaining optically interconnected by PRC 304, as shown in FIG. 3B. Light coupled into waveguide 304 on one of the PIC segments (e.g., light coupled into first end 304e) can be transmitted by PRC 304 across the gap and onto the other PIC segment (e.g., PIC 302a), e.g., as shown in FIG. 3C.

As described above, in some configurations, the first chip and the second chip may be formed by cleaving a third chip into two while leaving a PRC intact across the cleave. During fabrication, a medial portion of the waveguide between the first and second ends may be released from the third chip while the ends remain anchored, thereby permitting the PRC to bridge the cleaved chips. The separation distance between interconnected components can be at least 10 cm and, in some cases, at least 1 m. This separation may allow the PRC to maintain optical continuity across physically distant components. The PRC may couple components that occupy distinct thermal environments, such as a first photonic component located in a cryogenic environment and a second photonic component located in a room-temperature environment. An exemplary PRC may couple an optically sensitive component to an optically noisy component, maintaining interconnection while permitting physical separation that reduces noise interference.

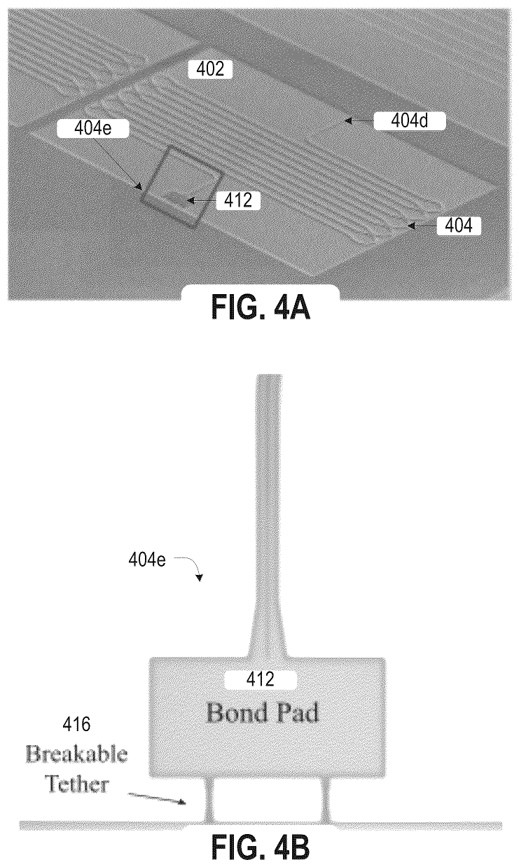

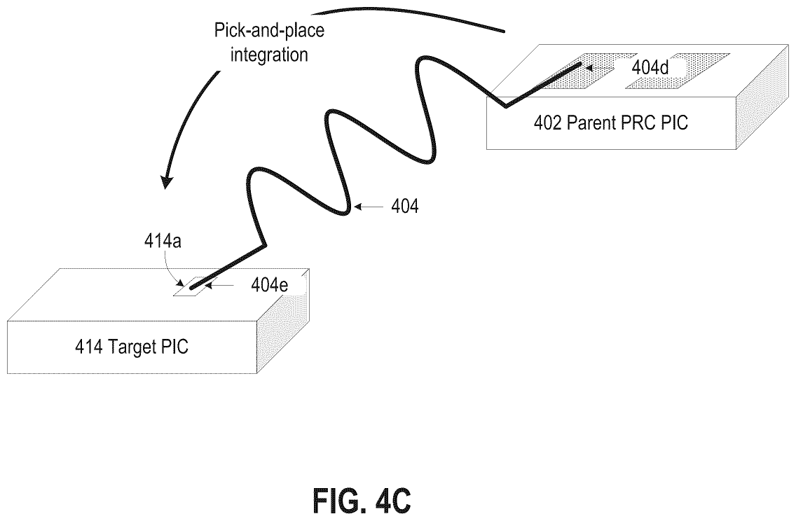

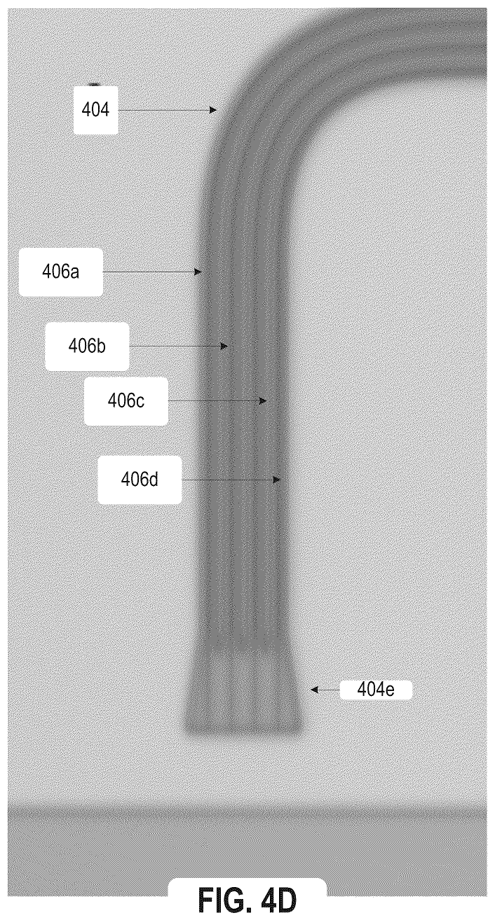

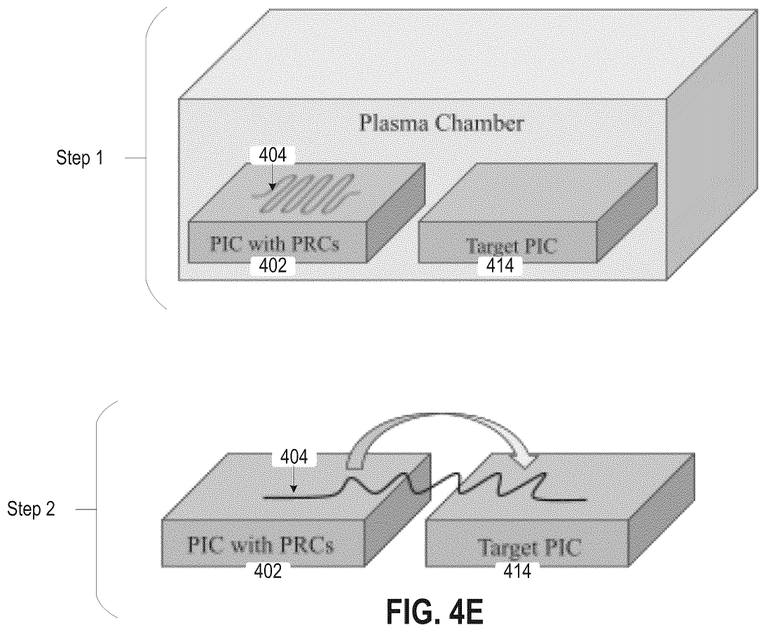

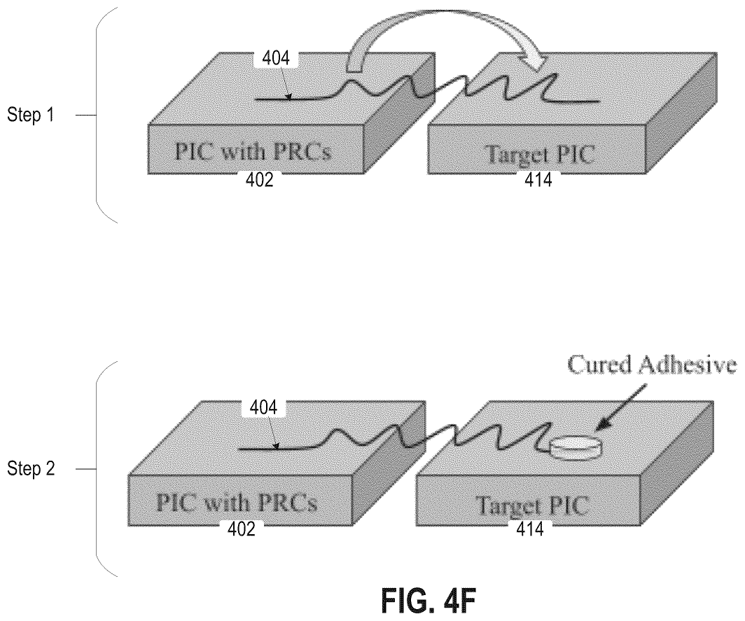

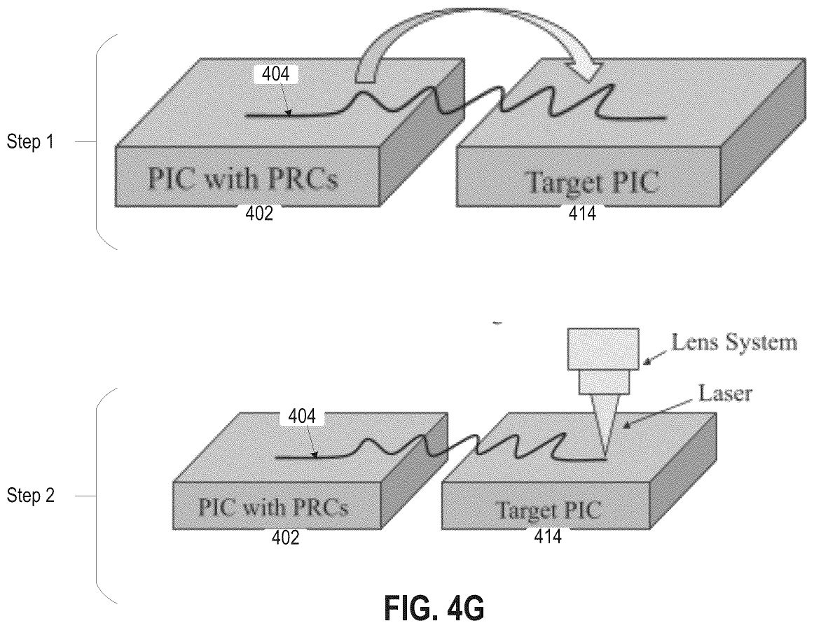

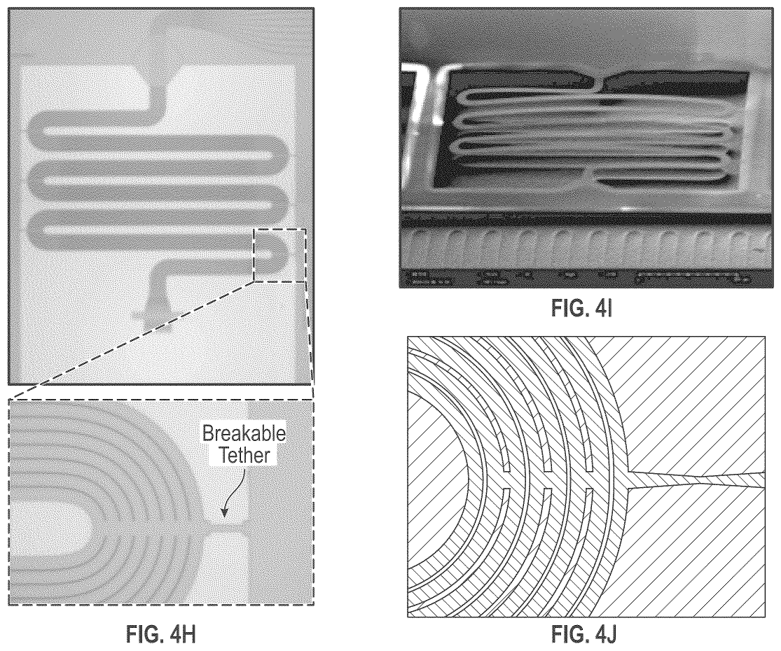

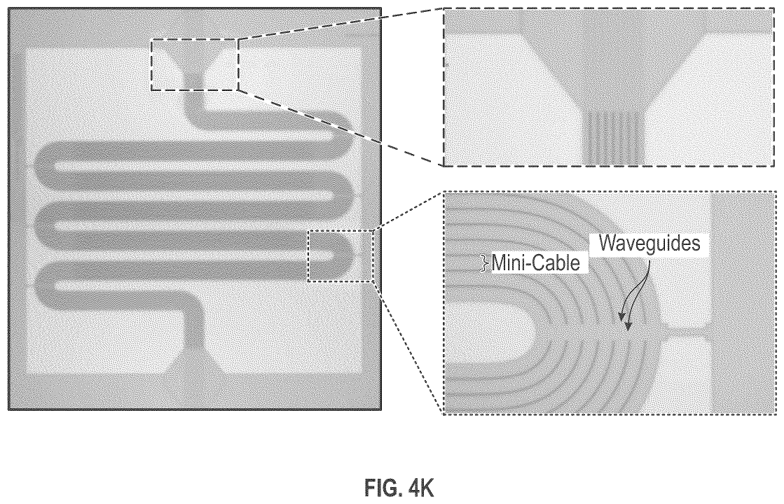

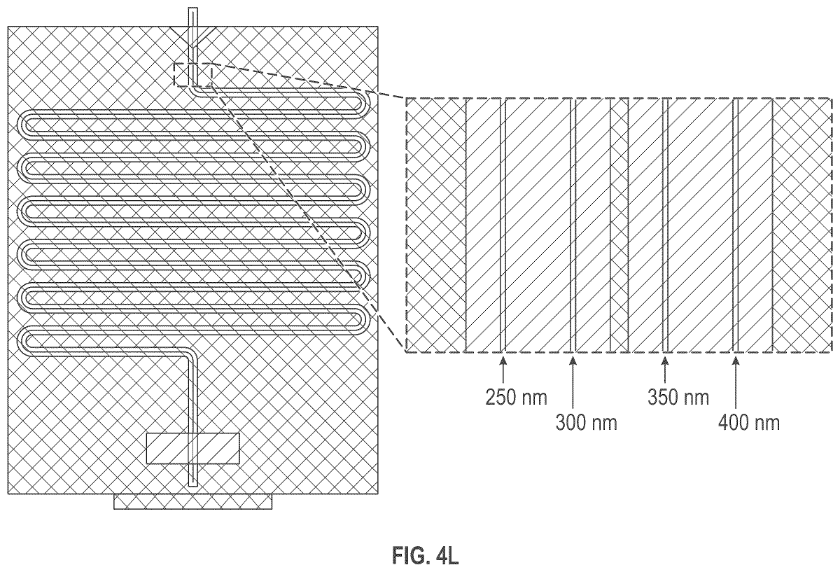

In addition to enabling a single chip to be divided into multiple chips, a PRC that is configured for in-plane extension (e.g., PRC 204) can be used to connect photonic components that are initially separate. For example, a PRC that is configured for in-plane extension can be used to connect optical components on the chip on which the PRC is fabricated to optical components that are not on the chip (e.g., optical components on a different chip). FIGS. 4A-4G depict various components of an exemplary PRC 404 used to connect photonic components that are initially separate. As shown in FIG. 4A, PRC 404 has an “accordion” geometry and is formed on a first PIC 402. When PRC 404 is released, all but one end portion 404d of PRC 404 may be undercut and released from PIC 402. The released portion of PRC 404 can then be lifted from PIC 402, extended, and connected to a second PIC 414 (FIG. 4C).

Second PIC 414 may have been fabricated separately from PIC 402 and can be composed of structures and materials that are entirely different from first PIC 402, that is, structures and materials that are entirely different from the chip or wafer fabricated with PRC 404. PRC 404 therefore enables optical components in two initially distinct circuits to be easily connected, thereby enabling the efficient assembly of large, complex photonic systems.

In some embodiments, the releasable end 404e of PRC 404 includes a bond pad 412 for bonding and optically coupling waveguide 404 to another optical component (FIGS. 4A-4B). Bond pad 412 can be a mechanical element that provides a large (relative to the width of PRC 404) contact area that is easy to pick up and that improves bonding of PRC 404 to PIC 414. PIC 402 may be configured such that, after PRC 404 is released, one or more breakable tethers 416 remain to anchor bond pad 412 to PIC 402 until it is time to connect PRC 404 to PIC 414. PIC 414 can include an alignment feature 414a (e.g., alignment markings) for aligning bond pad 410 such that PRC 404 connects with the correct component of PIC 414.

In some implementations, the receiving chip may include elongated trenches, recesses, or features in the underlying layers that serve as alignment features for the bond pad or waveguide ends of the PRC. In some implementations, the alignment features may be visual (e.g., surface markings, fiducials, or other non-topological indicators), thereby providing positional reference without involving physical recesses and/or raised structures. These trenches may provide additional lateral constraint compared to sockets or visual alignment markings, thereby improving repeatability of pad placement and/or bonding.

Bond pad 412 can comprise any suitable material. In some embodiments, bond pad 412 comprises silica (SiO₂). In some embodiments, bond pad 412 comprises metal. In some embodiments, bond pad 412 comprises metal and silica. In some embodiments, bond pad 412 includes a combination of waveguide, cladding, and metal layers. The size of bond pad 412 may depend on the number waveguide channels in PRC 404. In some embodiments, bond pad 412 is micron-to millimeter-scale.

In other embodiments, the releasable end 404e of PRC 404 does not include a bond pad or breakable tethers. An example releasable attachment end 404e of a PRC 404 that does not include a bond pad or breakable tethers is provided in FIG. 4D.

In some embodiments, PRC 404 can have multiple waveguide channels 406a-406d, as shown in FIG. 4D. Adjacent waveguide channels (e.g., waveguide channel 406a and waveguide channel 406d) can be separated by a layer of cladding material. As previously discussed with reference to FIG. 1C, in some embodiments, individual waveguide channels are separated across the meandering length of the PRC. In other embodiments, individual channels are fully joined (e.g., with SiO₂ cladding) throughout the entire meandering length of the PRC. In embodiments wherein the individual channels are fully joined, all waveguide channels may be fully connected and may not be separable at any point. Waveguide channels may be connected and/or joined together at the released end of the PRC by tapering out the cladding on each channel which may according to some embodiments increase the total cladding width of each channel such that is greater than the pitch and/or period of the waveguide channels. In some embodiments, the individual waveguide channels are connected only at one or both ends of the meandering length of the PRC. If the channels are only joined together on one side, each channel can be positioned independently to connect to different locations on a target chip.

Different waveguide channels of the multiple waveguide channels may be configured to transmit different optical wavelengths. At least two of the waveguide channels may have different cross-sectional widths to tailor mode guidance for distinct wavelength ranges. One or both ends of the PRC may include bond pads that may include one or more alignment features (e.g., etched sockets, trenches, recesses, visual alignment marks, and/or complementary latching structures on a receiving chip). Such bond pads may be configured for attachment by van der Waals forces, bonding using adhesives, wire bonding, thermal reflow bonding, and/or laser welding. Breakable tethers may be provided to hold a bond pad in place until the PRC is ready to be bonded. The use of tapered cladding and/or adiabatic transition regions at the ends of the channels may further enlarge an optical mode prior to coupling to a target photonic component.

These individual channels may be more mechanically compliant than the PRC as a whole. In other embodiments, for increased manageability, the individual waveguide channels are connected at both ends, and the PRC comprises thin tethers configured to connect the channels to its parent chip throughout the meandering length of the PRC. The individual channels can also be connected together periodically throughout the meandering length of the PRC for increased manageability. A number of methods can be used to attach the released end of a PRC (e.g., PRC 404) to a target photonic component (e.g., PIC 414). When a PRC includes a bond pad, the bond pad can be integrated onto the target component through any suitable means, for example using commercially available pick-and-place tools and/or die bonders. In some embodiments, Van der Waals forces between the released end of the PRC and the target optical component are sufficient to attach the PRC to the target component, particularly when the PRC includes a bond pad. In other embodiments, depending on the material composition of the PRC and the target optical component, direct bonding techniques (e.g., techniques wherein bonding is accomplished through a combination of intermolecular interactions including van der Waals forces, hydrogen bonds and strong covalent bonds) can be used to attach the PRC to the target optical component. A direct bonding technique can include a combination of steps such as, for example, a combination of one or more of the following steps: sample cleaning; ion bombardment or plasma treatment (using gases such oxygen, nitrogen, argon, etc.); contacting the ribbon cable to the target PIC (ideally in vacuum conditions); and/or annealing.

For both Van der Waals and direct bonding methods, adhesion can be improved using plasma treatment, heat, or by bonding in vacuum conditions. FIG. 4E provides a schematic of an example process for Van der Waals or direct bonding of PRC 404 to target PIC 414. As shown, PIC 402 and PIC 414 may first be preprocessed, for example using plasma treatment (step 1). The released end of PRC 404 can then be pick-and-place integrated to PIC 414 (step 2). Optionally, the pick-and-place integration can be performed with heat and/or in vacuum conditions and/or can be followed by annealing.

Bonding between the released end of a PRC (e.g., released end 404e of PRC 404) and a target photonic component (e.g., PIC 414) can also be accomplished using an adhesive. As shown in FIG. 4F, PRC 404 may first be aligned and contacted with PIC 414 (step 1). An adhesive may be administered to the contact area and then cured (step 2).

Depending on the material compositions of the PRC (e.g., PRC 404) and the target photonic component (e.g., PIC 414), precise localized bonding can be accomplished by focusing a high-power laser onto the bonding area. FIG. 4G shows a schematic of an example laser bonding process. The released end of PRC 404 may first be aligned and contacted with PIC 414 (step 1). A focused laser can then be scanned across the bonding area to locally heat and melt the bonding area of the PRC and/or the target component, causing the PRC to become permanently attached to the target component after cooling (step 2).

FIGS. 4H-4J depict breakable tether designs that may be included to hold PRCs passively in place after undercutting. Depending on layer thickness and stress, PRCs may deform out-of-plane once released, complicating handling and/or causing tangling. To address this, tethers may be positioned periodically throughout the meandering geometry, for example at each 180-degree bend, to maintain the cable in a socket until use. Tethers may be designed to break cleanly when the PRC end is pulled. For example, tether types may include a column-type tether (e.g., as shown in FIG. 4H) and an hourglass-type tether (e.g., as shown in FIG. 4J). FIG. 4I depicts an exemplary undercut PRC with tethers at each bend.

FIG. 4K depicts a PRC with multiple waveguides separated into mini-cables. For example, sixteen total waveguides may be grouped into eight mini-cables, each mini-cable containing two waveguides. The mini-cables may be joined at the ribbon cable ends and may optionally be joined periodically at bends to improve organization and/or ordering of the mini-cables. Each mini-cable may be fabricated via the same etching processes and may be collectively configured for high-density interconnection.

FIG. 4L depicts a PRC in which different waveguides are fabricated with different cross-sectional widths. As shown, four waveguides may each have a distinct cross-sectional width (e.g., 250 nm, 300 nm, 350 nm, and/or 400 nm). Such differentiation may enable optimization for single-mode and/or multi-mode propagation of different optical wavelengths. In some implementations, for example, wider waveguides may be used along straight segments to reduce propagation losses, while narrower waveguides may be used in bends to suppress multimode coupling. Adiabatic taper transitions, which may take on linear, sinusoidal, parabolic, or other smooth forms, may be used to transition between cross-sectional widths.

In some embodiments, a PRC is configured to be removed completely from the PIC on which it is fabricated. Following removal, each end of such a PRC can be separately attached to a different target photonic component. In other words, a PRC can be fabricated independently of the photonic components that it is intended to optically interconnect. This may allow the optical and mechanical properties of the PRC to be optimized using specialized materials and fabrication processes without compromising the design and properties of the target PICs.

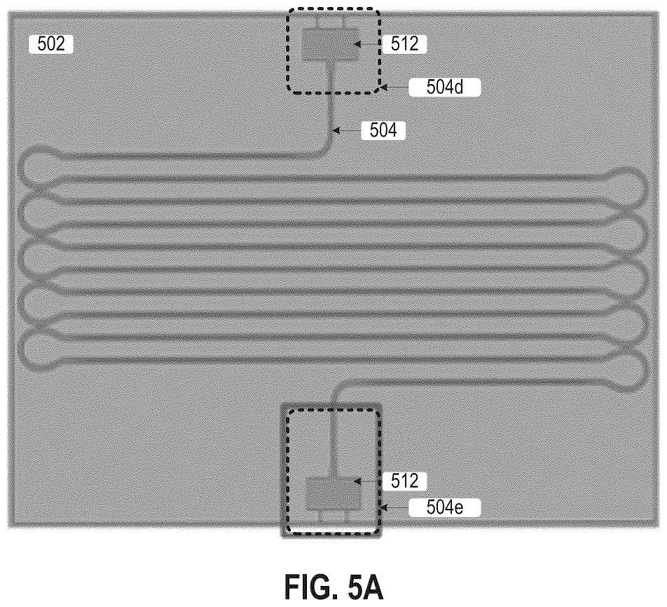

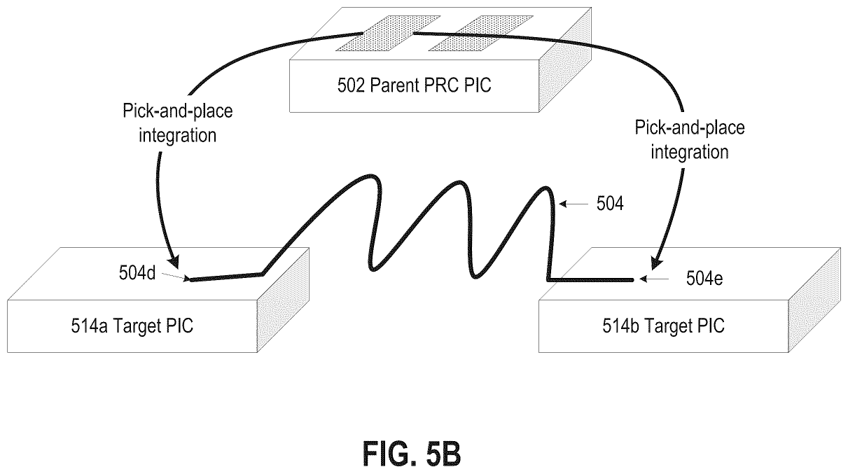

An example such PRC 504 is depicted in FIGS. 5A-5B. As shown, PRC 504 may be fabricated on a PIC 502. PRC 504 may be released such that the entirety of PRC 504 is completely removable from PIC 502. PRC 504 can be used to optically interconnect two target PICs 514a-514b by removing PRC 504 from PIC 502, bonding a first end 504d of PRC 504 to target PIC 514a (e.g., using one of the bonding techniques described above with respect to FIGS. 4E-4G) and bonding a second end 504e of PRC 504 to target PIC 514b (e.g., using one of the bonding techniques described above with respect to FIGS. 4E-4G). In some embodiments, one or both ends 504d-5043 of PRC 504 includes a bond pad 512 that remains tethered to PIC 502 by one or more breakable tethers after PRC 502 is released. In other embodiments, neither end of PRC 504 includes a bond pad.

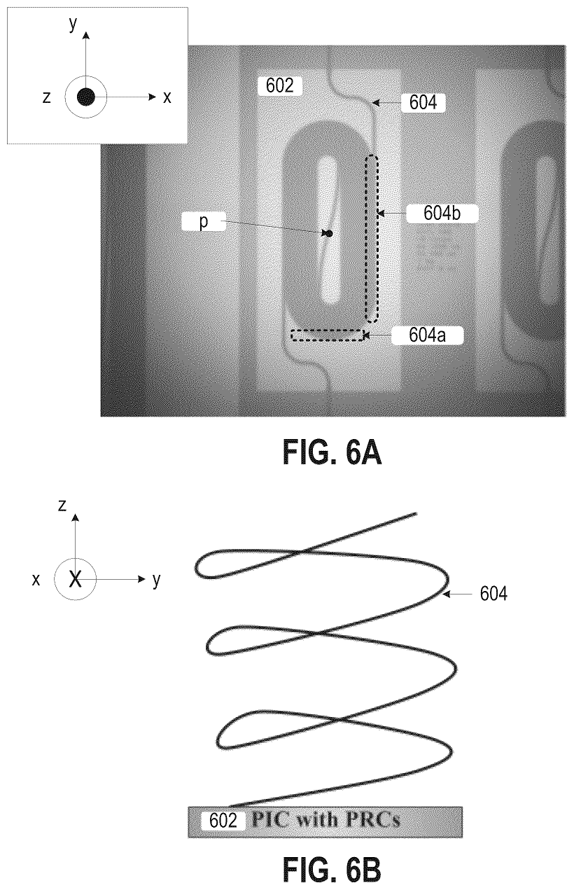

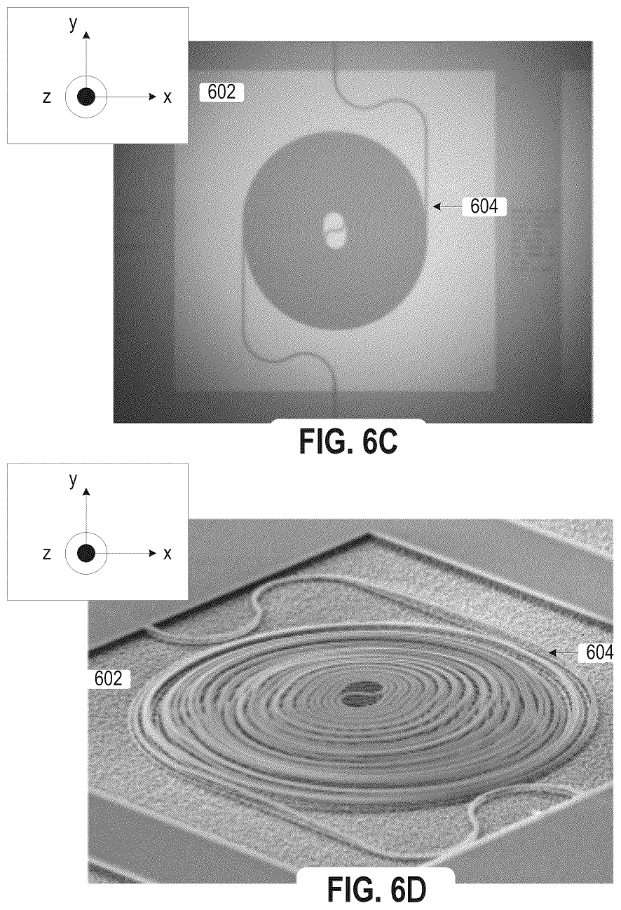

PRCs can also be optimized for out-of-plane extension, enabling the construction of three-dimensional photonic systems. A PRC 604 that is configured for out-of-plane extension is shown in FIGS. 6A-6D. PRC 604 can be formed on a chip 602 and can have a concentric spiral geometry comprising linear segments (e.g., segment 604b shown in FIG. 6A) connected by curved segments that turn 180 degrees and decrease in radius of curvature toward the center (labeled “p” in FIG. 6A) of PRC 604. When a medial portion and at least one end of PRC 604 is undercut and released, PRC 604 can be extended out of the plane of chip 602 (e.g., the x-y plane in FIGS. 6A-6D), for example in a direction perpendicular to chip 602 (e.g., in the z direction indicated in FIGS. 6A-6D). PRC 604 can therefore be used to (for instance) connect an optical component on PIC 602 to an optical component positioned above chip 602.

If the length of the linear segments of PRC 604 is long relative to the length of the curved segments PRC 604 may have a “paperclip” geometry comprising concentric elliptical spirals, as shown in FIG. 6A. If the linear segments of PRC 604 are shorter, PRC 604 may have an “apple peel” appearance comprising concentric circular spirals, as shown in FIGS. 6C-6D.

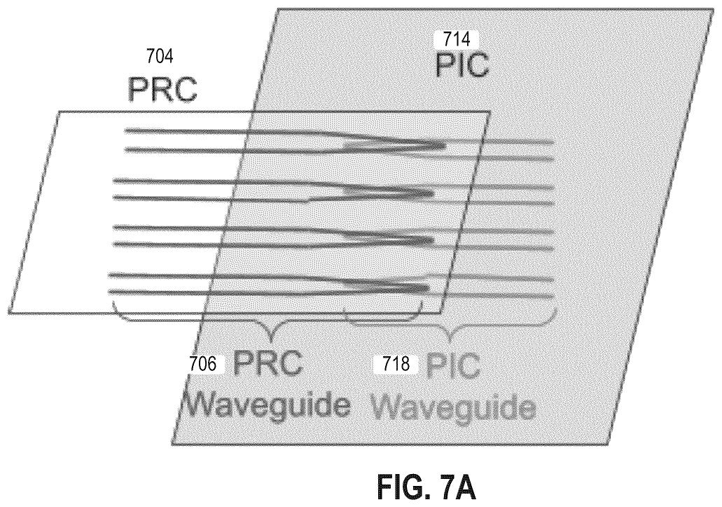

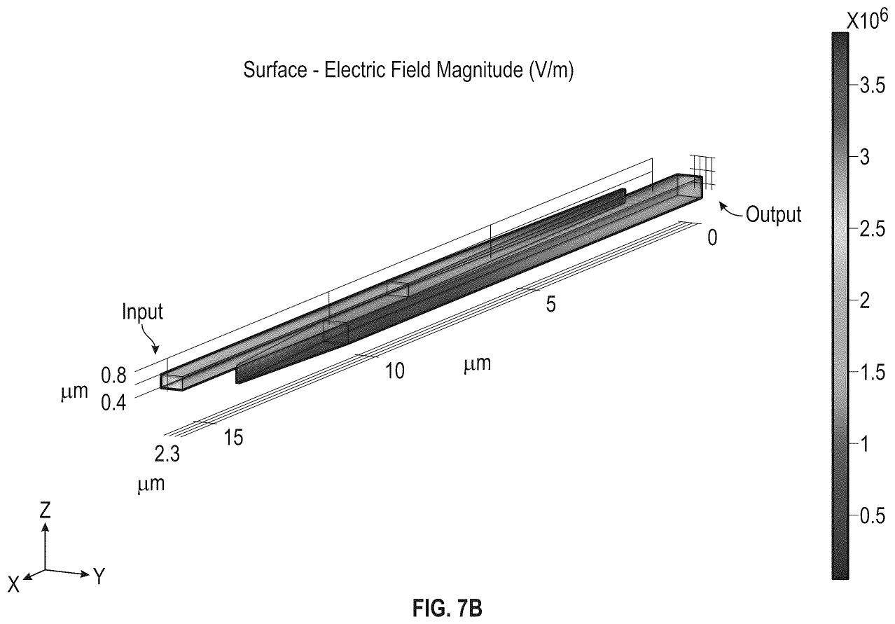

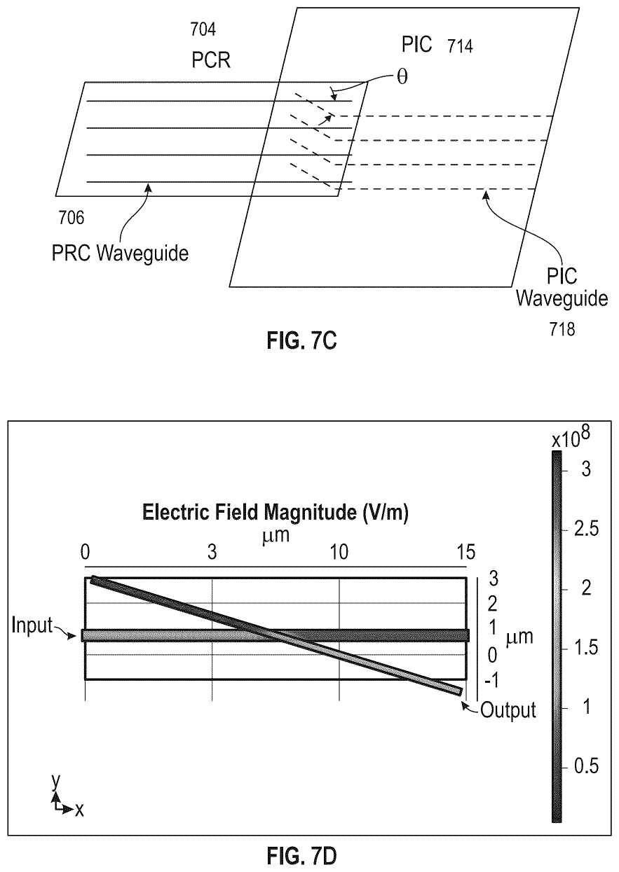

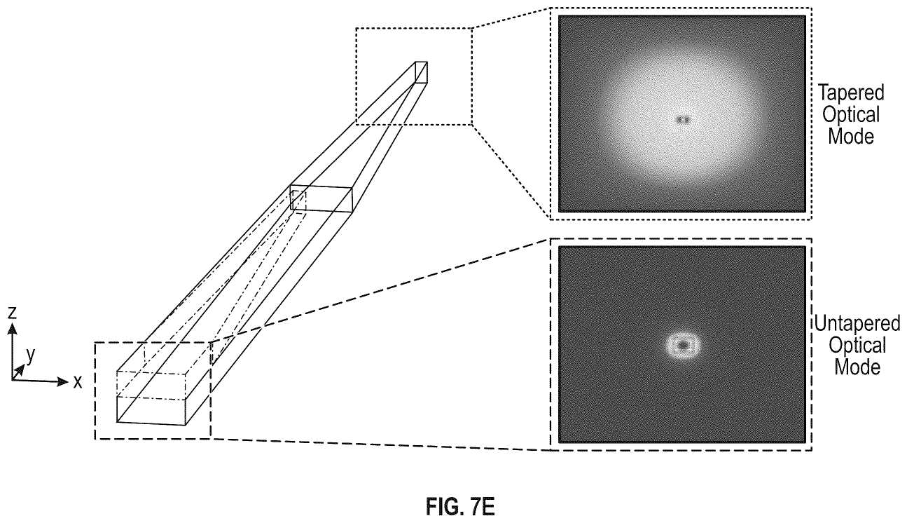

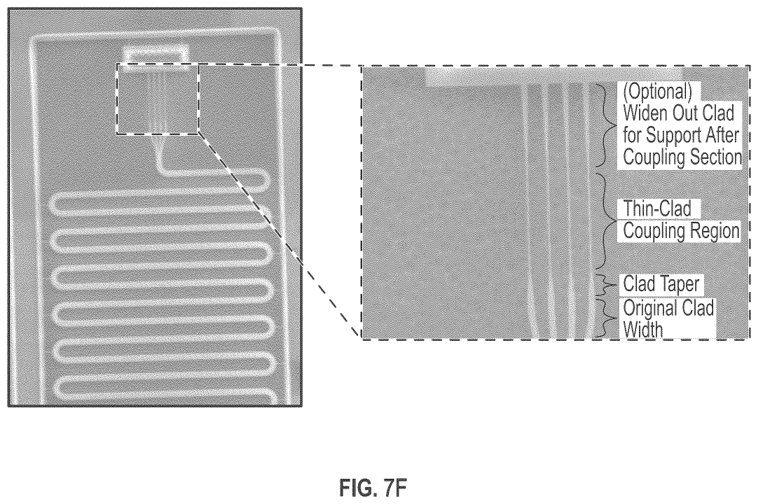

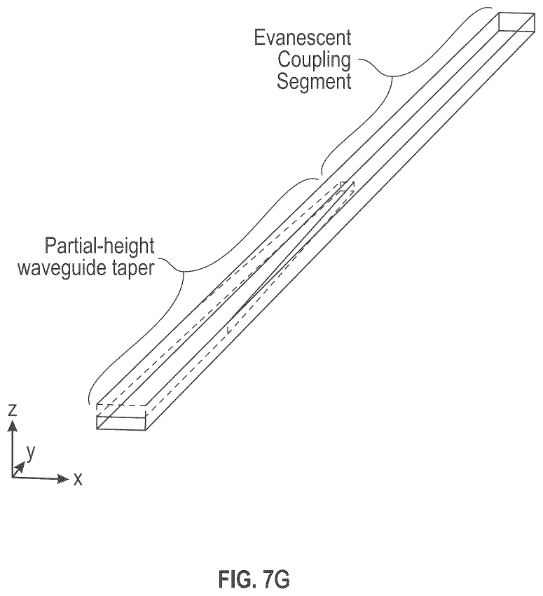

The optical coupling interface between a PRC and a target PIC can be designed in a variety of ways. For example, as illustrated in FIG. 7A, out-of-plane coupling between a PRC 704 (for simplicity, only termination portion of PRC 704 is illustrated) and a PIC 714 can be accomplished by adiabatically transferring the guided mode(s) of a PRC waveguide 706 to a waveguide 718 on target PIC 714 (or vice versa) using an inverse taper geometry for the widths of the waveguides. A perspective view of a finite element method (FEM) optical coupling simulation demonstrating adiabatic coupling between two waveguides with inverse tapers is shown in FIG. 7B.

Out-of-plane coupling between a PRC 704 and a target PIC 714 can also be accomplished by evanescently coupling a PRC waveguide 706 and a PIC waveguide 718, as depicted in FIG. 7C. In evanescent coupling, the optical mode of one waveguide may extend beyond the physical boundary of its core as an evanescent field, and when this field spatially overlaps with the mode of an adjacent waveguide, optical power may be transferred between the two structures without involving direct face-to-face contact. PRC waveguide 706 and PIC waveguide 718 can be designed to have matched effective refractive indices for overlapping guided modes of interest. If the intersection angle θ of the two waveguides is equal to 0°, optical power can transfer between the waveguides due to their overlapping mode fields (i.e., as it does in a traditional directional coupler). When θ>0, in-plane translation of PRC waveguide 706 relative to PIC waveguide 718 will not change the interaction region or wave vectors of the optical modes of the waveguides. This “alignment-free” optical coupling interface is shown between 4 PRC waveguides and 4 PIC waveguides in FIG. 7C. A top-down view of a finite element method (FEM) optical coupling simulation demonstrating the alignment-free coupling interface is provided in FIG. 7D. Additional information about alignment-free coupling can be found in US2022/0146749A1, the entire contents of which is incorporated herein by reference.

FIG. 7E depicts a PRC with a two-stage taper for adiabatic coupling. In a first stage, the upper portion of the waveguide core width may be tapered to transfer the optical mode to a thinner region of the waveguide (e.g., a fractional-height region, such as a region that is half the waveguide core height or that is another fraction of the waveguide core height). For example, in FIG. 7E, this thinner region of the waveguide includes the lower portion of the waveguide core. In a second stage, the waveguide width may be tapered down to further expand the mode into the cladding. These stages may be implemented at the PRC coupler, the target chip coupler, or both. In some implementations, tapering may occur over more than two stages.

FIG. 7F depicts an embodiment in which the cladding itself is tapered to narrow in the coupling region. In some implementations, the cladding taper may principally be a width-wise taper, in which the lateral width of the cladding is reduced. Because the surrounding air provides stronger confinement than the cladding, decreasing the lateral width may force the guided optical mode to expand more vertically through the cladding, thereby enhancing overlap with the target waveguide's mode. In some implementations, the taper may reduce cladding thickness in the vertical direction (e.g., in the Z direction) while maintaining or even increasing cladding thickness laterally (e.g., in the XY plane). In some implementations, this reduction of cladding thickness in the vertical direction may include thinning down the PRC's top cladding to force the mode downward. Such reductions of cladding thickness in the vertical direction may thus involve a thin-clad region above and/or below the waveguide core that may allow the optical mode to expand more strongly in the vertical direction, thereby increasing overlap with the target waveguide's mode. Outside of the coupling section, the cladding may optionally widen again vertically to restore mechanical stability and reduce scattering, while remaining sufficient to confine the mode horizontally.

FIG. 7G depicts an embodiment of an evanescent coupling interface between a PRC and a target photonic integrated circuit. Similar to the adiabatic coupling method described above, this evanescent coupling method may be hindered if the gap between the PRC waveguide cores and the target chip waveguide cores is relatively large. To assist with mode overlap in such cases, both a cladding taper and/or a partial-height waveguide taper may be implemented prior to the evanescent coupling segment. These tapers may reduce the effective cladding thickness and shift a portion of the guided mode vertically or laterally, thereby allowing a larger fraction of the optical field to extend outside the core and overlap with the nearby target waveguide, which may improve evanescent interaction. Along the coupling region itself, however, the waveguide and cladding cross-sections may remain constant to maintain stable optical power transfer between the overlapping mode fields.

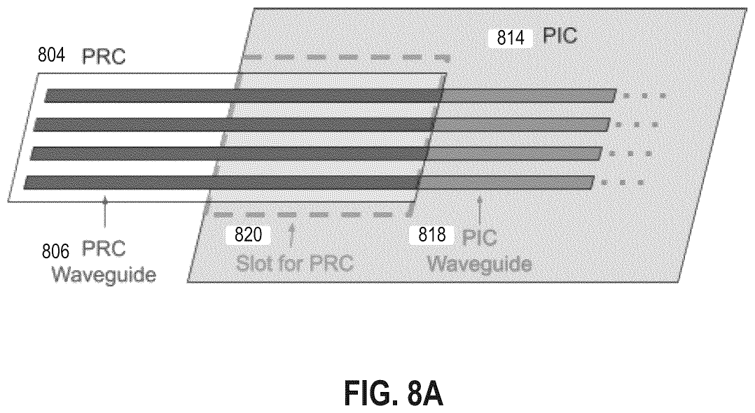

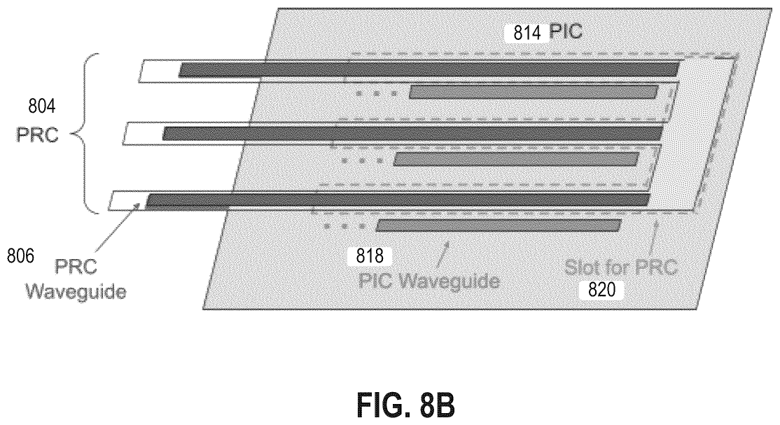

In-plane coupling between a PRC and a target PIC can be accomplished via endfire coupling, as illustrated in FIG. 8A. Target PIC 814 can be fabricated with a slot 820 that is configured to receive an end portion of a PRC 804. Slot 820 may align the ends of each PRC waveguide 806 with the ends of respective PIC waveguides 818 when PRC 804 is placed in slot 820 such that, when the optical mode of a PRC waveguide 806 exits its facet, it directly couples into the facet of a PIC waveguide 818 (or vice versa).

FIG. 8B depicts another technique for accomplishing in-plane coupling a PRC and a target PIC. PRC 804 in this case includes a plurality of waveguide channels 806 that are disconnected from one another along their lengths. A plurality of slots 820 corresponding to the plurality of waveguide channels 806 can be etched into target PIC 814. Each slot 820 may be etched at least partially alongside a waveguide 818 in target PIC 814 so that each waveguide 806 can be placed side-by-side with a waveguide 814, enabling evanescent coupling of the PRC and PIC waveguides via their overlapping mode profiles (e.g., similar to a directional coupler).

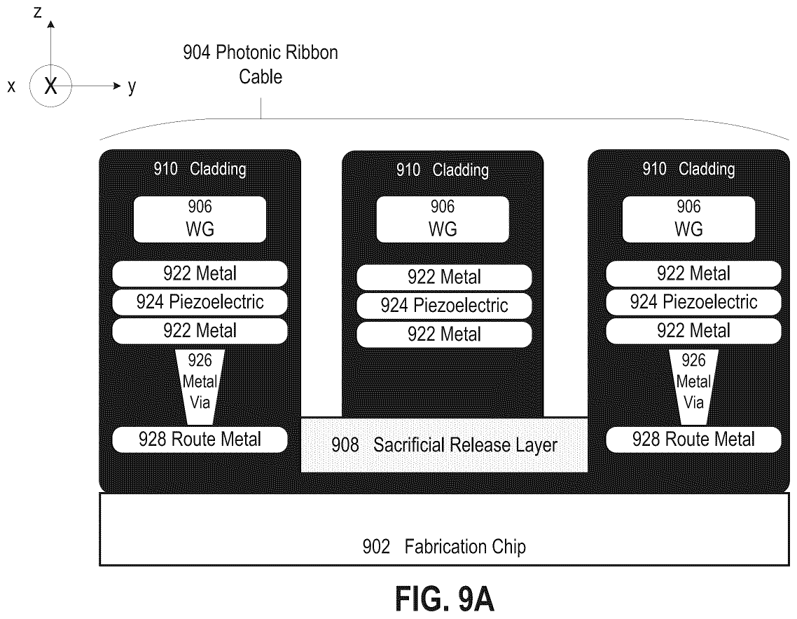

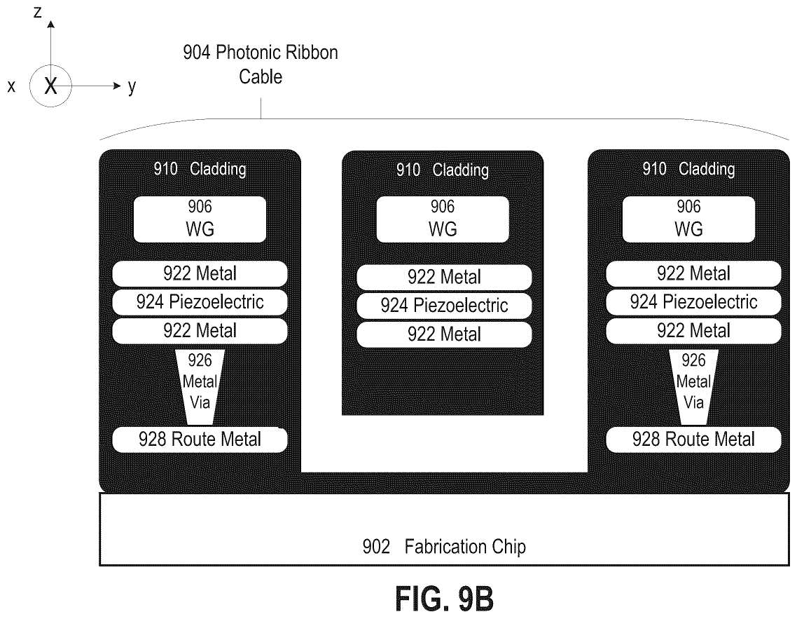

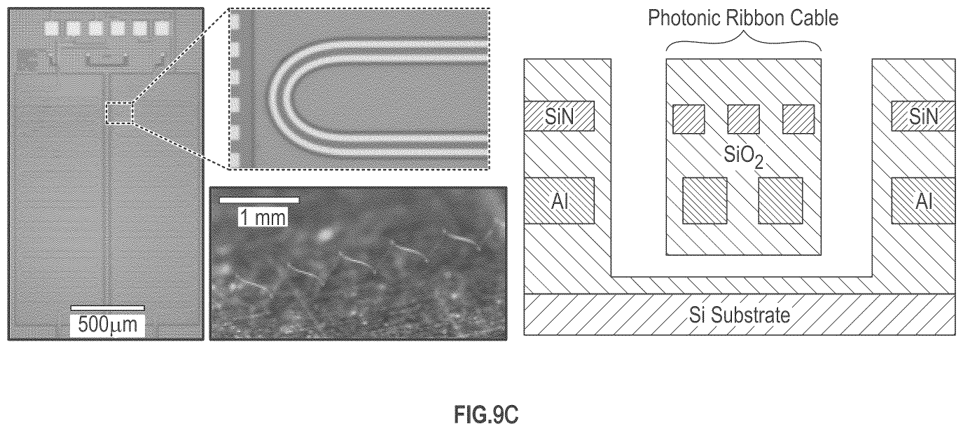

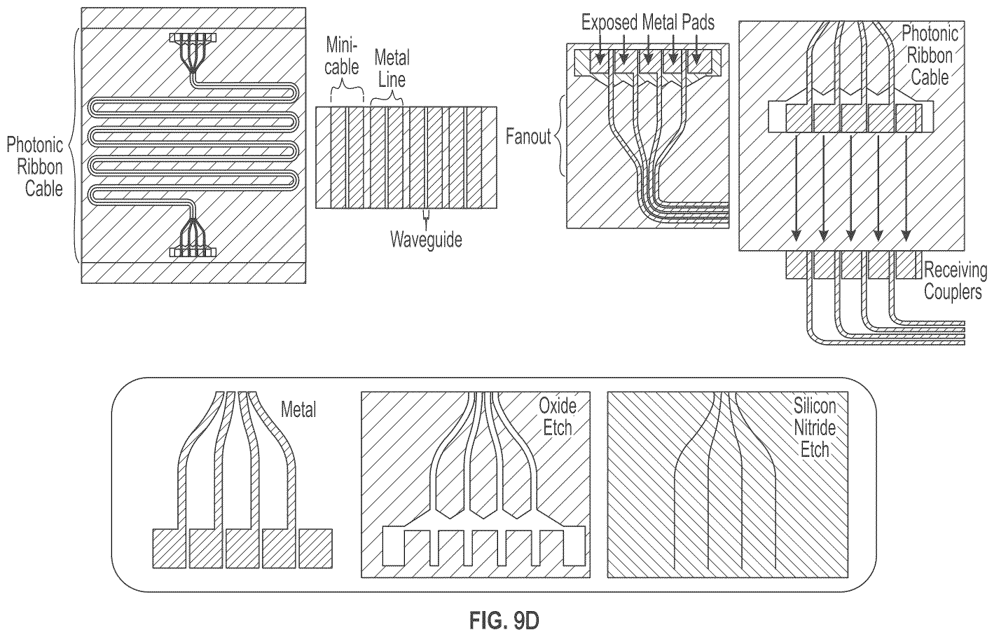

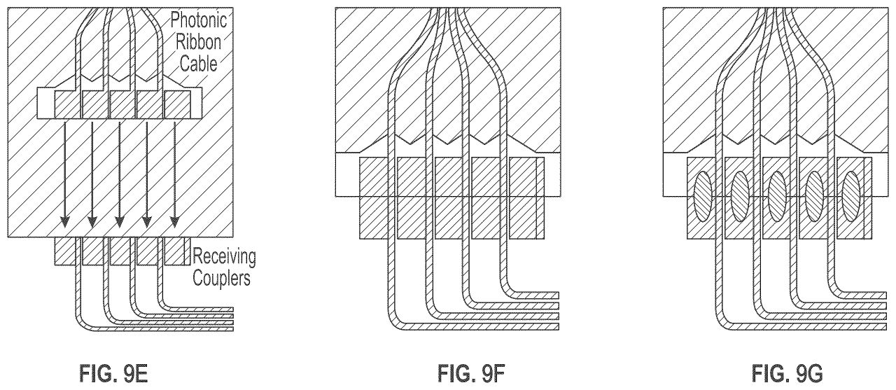

In some embodiments, a PRC is configured to function as an electrical interconnect as well as an optical interconnect. FIGS. 9A-9B show cross-sectional views of an exemplary PRC system 900 for fabricating a PRC 904 that can act as both a photonic and an electronic coupler. PRC 904 can be fabricated on a chip 902 and, in addition to a waveguide 906, can include layers for electrically interconnecting PRC 904 to other electrical components (metal via layer 926 and route metal layer 928). Metal layers 922, metal via 926, and route metal 928 can be formed from any suitable metals, for example aluminum (for metal layers 922 and route metal 928) and tungsten (for metal via 926). For example, multiple distinct metal layers can be included in a single PRC.

In some implementations, fabrication of the PRC may begin with deposition of a cladding layer such as a base oxide (e.g., SiO₂) onto a silicon wafer. The oxide may be planarized by chemical mechanical polishing (CMP) to provide a uniform surface and to remove thickness variations. A core material such as silicon or silicon nitride may then be deposited as a thin film. This core film may be patterned using mask-based photolithography, followed by reactive ion etching (RIE) to define the geometry of the waveguide. Following patterning of the core, an upper oxide cladding may be deposited to encapsulate the waveguide, and CMP may again be used to achieve a desired cladding thickness. Trenches may then be opened through the oxide using lithography and dry etching. The trenches may extend through the cladding and core regions down to the underlying silicon substrate and provide access paths for later release of the PRC structure. A selective dry etch, such as xenon difluoride (XeF₂), may be applied through the trenches to remove portions of the underlying silicon substrate, thereby undercutting the ribbon structure and releasing it from the substrate.

Additionally, or alternatively, PRC 904 can include layers for piezoelectric actuation (a layer of piezoelectric material 924 sandwiched between a pair of metal layers 922). Piezoelectric layer 924 can likewise be formed from any suitable piezoelectric material, for example aluminum nitride (AlN). Piezoelectric actuation can be used to induce a change in stress in the PRC. In some embodiments, piezoelectric actuation can be used to induce out-of-plane curling along the length of the PRC. In other embodiments, piezoelectric actuation can be used to push different sections (e.g., different waveguide channels) of the PRC together or to pull different sections (e.g., different waveguide channels) of the PRC apart. Piezoelectric actuation can also be used to induce phase shifts in a propagating optical signal (via strain-optic and moving boundary effects), or to otherwise maneuver the PRC.

In some implementations, the fabrication process may focus on forming the optical waveguide and cladding. For example, a base oxide cladding layer may first be deposited, a core layer may then be deposited on the base layer and patterned, and an upper cladding layer may then be deposited on the core layer as described above, followed by release etching. Optional post-processing steps such as thermal annealing may be applied to smooth the waveguide sidewalls and/or reduce scattering losses. In some implementations, a silicon-on-insulator (SOI) wafer can be used as the starting substrate when the waveguide core is silicon. Such use of an SOI substrate may reduce the need for separate deposition of a base oxide cladding layer and/or a silicon core layer.

Like the previously described PRCs, PRC 904 can have a winding geometry that, when sacrificial release layer is removed to release PRC 904 from chip 902, allows PRC 904 to extend away from chip 902 (either in-plane, similar to PRC 204, or out-of-plane, similar to PRC 604). A single PRC can therefore be used to interconnect both optical and electronic components on spatially separated circuits. PRCs therefore facilitate the creation of large-scale optoelectronic systems (e.g., quantum computing systems) that are both cost- and space-efficient by reducing the number of necessary interconnection components.

Although CMOS-compatible deposition, lithography, and/or etch processes may be effective for large-scale PRC fabrication, other methods may additionally or alternatively be used. For example, electron-beam lithography may directly form the waveguide pattern into the core layer. An electron-beam lithography-based approach may be advantageous for prototyping or research-scale devices that may involve high resolution.

FIG. 9C depicts a PRC that includes both optical waveguides and one or more embedded metal lines for electrical interconnection. Multiple electrical lines may optionally be included within a single PRC. Multiple metal lines may be included in each metal layer present in the PRC. The design shown may be monolithic, in which the PRC connects two parts of an originally single chip that may then be cleaved and separated while maintaining connectivity. In other implementations, the PRC may be configured for bondable electrical connection at one or both ends. An electrical conductor may be layered with the waveguide and/or follow the same winding geometry as the waveguide such that a first end of the electrical conductor is extendable away from a second end. The electrical conductor may include one or more metal layers within a cladding material and may provide electrical interconnects between the PRC and external electronic components. A piezoelectric layer may also be deposited within the cladding material. The piezoelectric layer may be electrically actuated to mechanically deform the PRC, thereby enabling phase shifting, movement of channels relative to each other, and/or controlled curling of the cable out of plane.

FIG. 9D depicts a PRC composed of four mini-cables, each mini-cable including its own optical waveguide and its own electrical line. The oxide, located between the mini-cables depicted in FIG. 9D, may be selectively etched away to define each mini-cable. Near the end(s) of the PRC, the mini-cables may fan out to a wider pitch. Each electrical line may terminate in an individual larger metal pad (e.g., a bond pad), and in some implementations the top surface of each pad may be exposed by etching away the overlying SiO₂. In the example shown, one extra metal pad is included (making five total pads) for symmetry but may not be connected to a metal line. In this embodiment, the optical waveguides may couple using endfire coupling, in which the faces of the PRC waveguides contact the faces of the receiving waveguides, and the optical modes transmit directly between the faces. The lower portion of FIG. 9D includes exemplary layouts for each of the metal, oxide, and silicon nitride layers, with hashed surfaces in the oxide and silicon nitride layer layouts indicating where oxide or silicon nitride, respectively, may be etched away.

FIGS. 9E-9G depict bonding methods that may be used to ensure electrical continuity between the PRC electrical lines and receiving couplers once the PRC pad is pressed against the receiving pad. In one option, metal-to-metal sidewall contact may complete the electrical connection, which may be held together by van der Waals forces. In another option, a strong electrical current may be passed through the lines after contact, causing resistive heating that reflows the metal to close any gaps between the pads. Alternatively, the chip may be heated until the metal reflows, or a localized laser may be used to weld the seam where the PRC pad and the receiving pad contact. In yet another option, the top surfaces of both the PRC pad and the receiving pad may be exposed by etching away SiO2, after which additional metal may be deposited across the pad surfaces to bond them, for example via wedge-bonding or ball-bonding using a wirebonder. In some implementations, electrical bond pads may be at least ten times larger than the tolerance required for optical alignment, reducing the difficulty of mechanical bonding while preserving precision for optical coupling.

### Example Application—Thermal And/or Optical Noise Isolation

When light is coupled into a PIC or scatters off of elements of a PIC, photons can be transmitted or guided outside of the intended waveguides (e.g., cladding or slab optical modes). The resulting optical noise can be significant and can interfere with photon detection, a necessary function in many optoelectronic systems (e.g., in quantum computers that utilize photonic qubits). Such detection may occur on-chip, for example via integrated photodetectors, or off-chip, for example by coupling light out of the PIC through a fiber or other optical interconnect to an external detector. PRCs can help to solve this problem by enabling the optically noisy portions of the PIC to be physically separated from, but still optically connected to, the optically sensitive region(s) of the PIC.

Similarly, some photonic applications require global thermal control and/or active electrical components that also generate heat. This can be problematic when thermal isolation of particular PIC components is needed, as is the case in cryogenic applications (e.g., superconducting nanowire single-photon detectors [SNSPDs], diamond color centers in quantum applications, etc.). PRCs can allow a thermally sensitive region of the PIC to be thermally isolated from the region(s) of the PIC that require(s) or generate(s) heat.

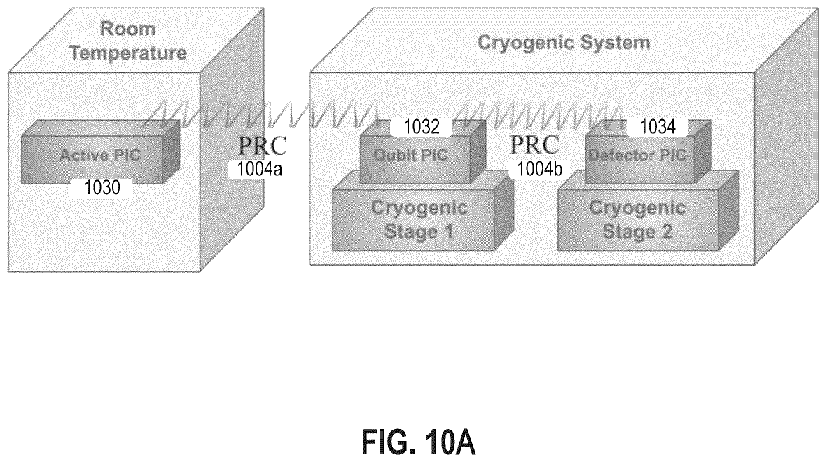

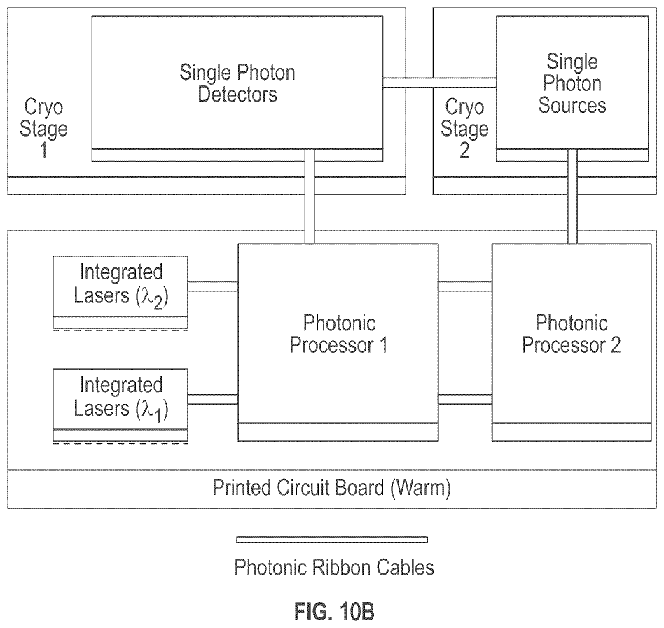

FIG. 10A shows a schematic of a quantum computing system that utilizes PRCs to interconnect a thermally sensitive photonic component, an optically sensitive photonic component, and a heat-generating optoelectronic component. Active PIC 1030 represents a photonic component with active electrical components that can generate heat. Qubit PIC 1032 represents a photonic component that requires thermal isolation but may be optically noisy. Detector PIC 1034 represents a photonic component that requires minimal optical noise. As shown, a first PRC 1004a can be used to optically connect PIC 1030 to PIC 1032, which can be thermally isolated from PIC 1030 in a cryogenic environment. A second PRC 1004b can be used to optically connect PIC 1032 to PIC 1034, which can be physically isolated from PIC 1032 to prevent optical noise interference.

FIG. 10B depicts an exemplary modular and hybrid photonic integrated circuit system interconnected with PRCs. PRCs may provide chip-to-chip optical and/or electrical connection between modular parts of a larger photonic integrated circuit. Separating components of a large photonic integrated circuit into modular components may allow direct reconfiguration of the circuit depending on the intended use. Because fabrication variation and errors may cause large monolithic photonic integrated circuits to fail or perform poorly, modular design may allow pre-selection of components that perform well prior to connecting them. Beyond monolithic systems, PRCs may also be used to optically and/or electrically interconnect different photonic platforms to produce hybrid photonic systems. For example, PRCs may connect components fabricated from lasing materials such as InGaN, GaAsP, InP, InGaAsP, and/or Ti:sapphire; high-speed electro-optic modulators such as LiNbO3 and/or BaTiO3; piezoelectric modulators such as AlN and/or PZT; photodetectors such as superconducting nanowire single-photon detectors, single-photon avalanche diodes, and/or PIN photodiodes; single-photon sources such as diamond vacancy centers and/or silicon T centers; and/or waveguide materials such as Si3N4, Si, and/or Al2O3. As shown in FIG. 10B, different chips may be mounted on separated stages and printed circuit boards or electronic backplanes depending on the application. For example, PRCs may form connections between components mounted to cryogenically cooled stages and components mounted to room temperature or heated printed circuit boards.

### Example Application—Tethered Photonics

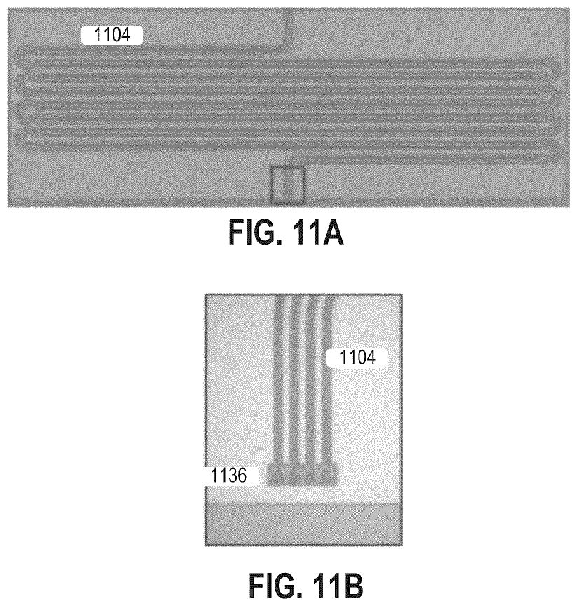

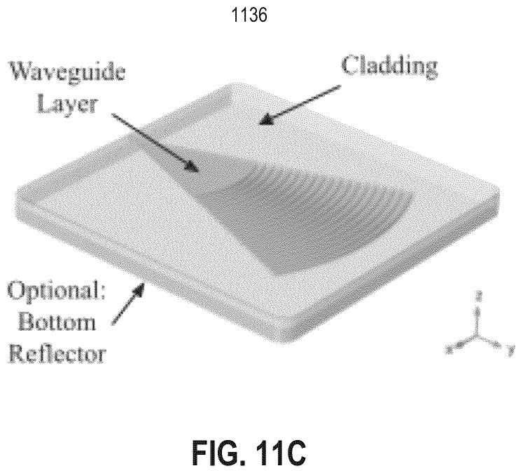

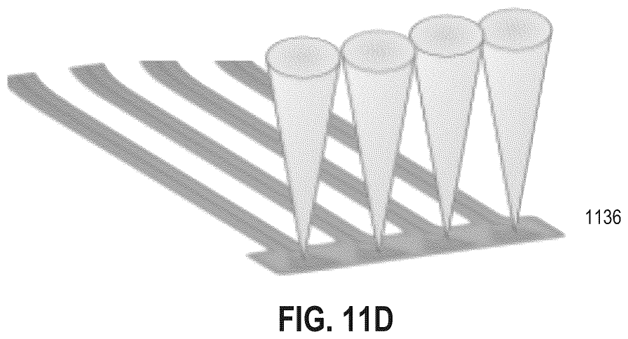

In addition to functioning as optical interconnects, PRCs can be used as long tethers for suspended photonic devices. For example, as shown in FIGS. 11A-11D, a PRC 1104 can comprise one or more terminal grating couplers 1136. Grating couplers 1136 may terminate each waveguide channel in PRC 1104. In some embodiments, a PRC with terminal grating couplers can be used for optically coupling to optical structures (e.g., on a target PIC) that are embedded too deeply beneath the surface of a chip for other optical coupling techniques (which often rely on relatively small waveguide-to-waveguide core spacings) to be effective. A PRC with terminal grating couplers can also be used as a tethered optical probe and can, in some embodiments, be maneuvered via piezoelectric actuation.

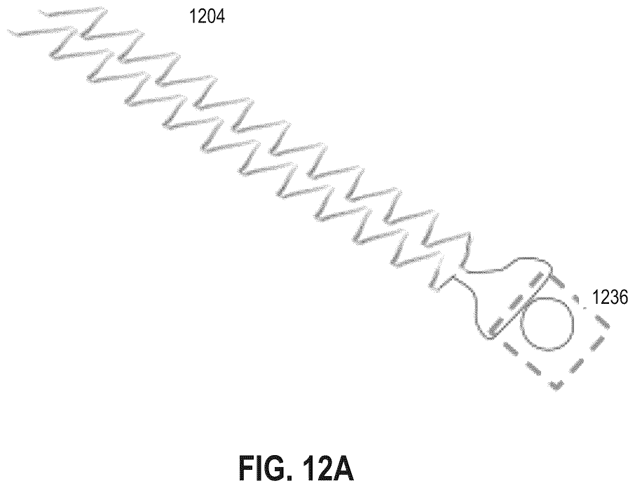

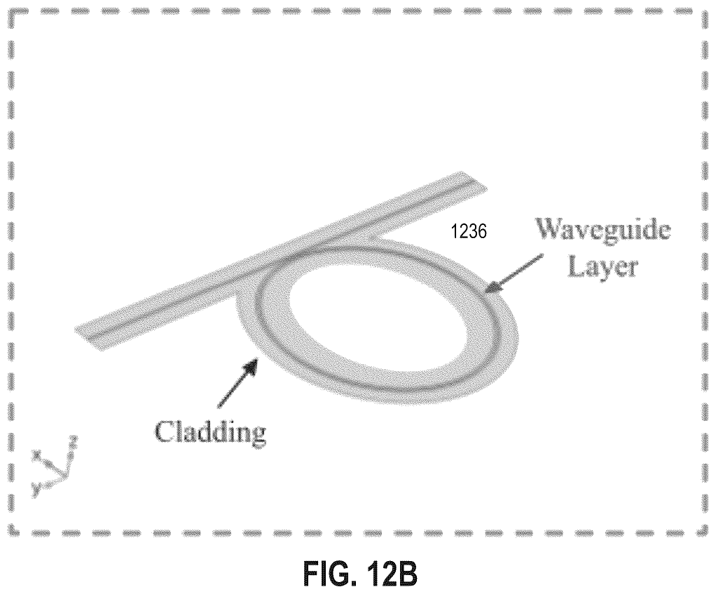

A PRC can also include a terminal ring resonator. FIGS. 12A-12B show a two-channel PRC 1204 with a terminal ring resonator 1236 that merges the two waveguide channels.

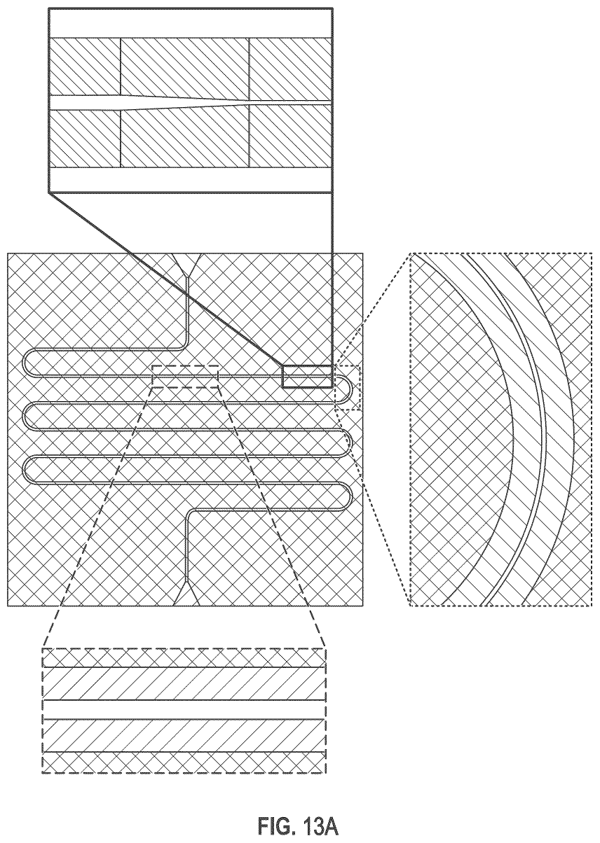

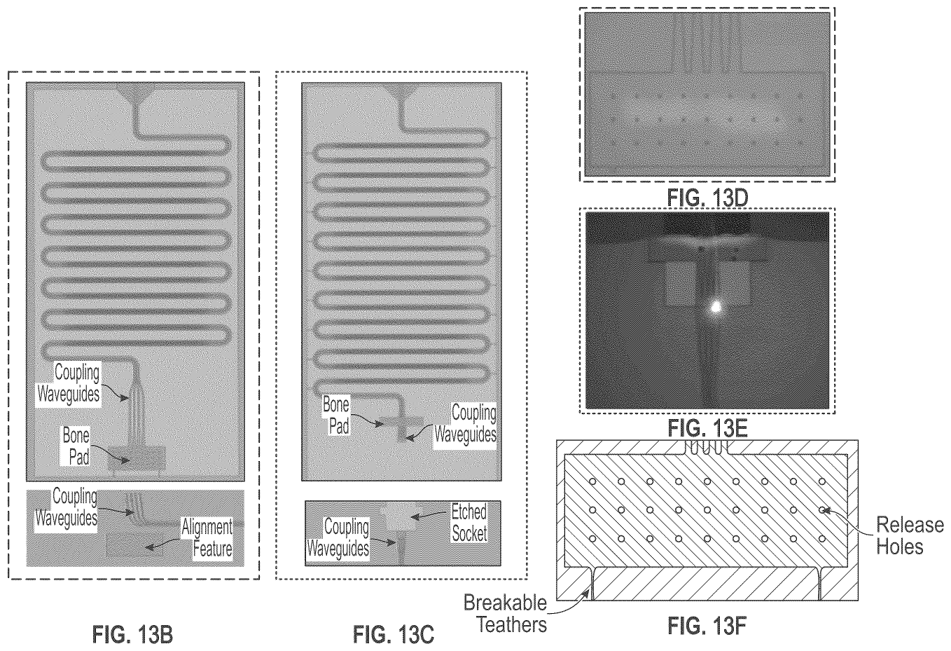

FIG. 13A depicts an embodiment in which the waveguide cross-section of a PRC may vary throughout the meandering length of the PRC rather than remaining constant. Along long, straight segments of the PRC, the waveguide core may be widened, in some implementations to a multi-mode width, in order to reduce propagation losses. For transmission in a single-mode regime, such widening may not pose issues because coupling into higher order modes is generally associated with abrupt perturbations, such as sharp bends, which are absent in straight segments. At bend locations, however, the waveguide core may be narrowed to maintain single-mode guidance and to suppress coupling into higher order modes that might otherwise occur due to curvature. To transition between wide and narrow segments, adiabatic taper regions may be employed, which may be designed with a variety of shapes, including linear, sinusoidal, or parabolic profiles. As shown in FIG. 13A, the middle straight segments of the PRC may employ wide, potentially multi-mode cores, while bends may use narrow single-mode cores, with smooth taper transitions provided before and after each bend to maintain optical mode stability.

FIGS. 13B-13F depict embodiments in which PRCs include large bond pads at one or both ends to mechanically assist with bonding. These bond pads may serve multiple functions. In some implementations, the bond pads may increase the surface area of the bonded end to provide greater mechanical robustness, particularly in implementations that rely primarily on van der Waals forces for adhesion. In other implementations, the bond pads may be designed to mechanically latch into etched sockets on a receiving chip, providing additional mechanical stability. Additionally or alternatively, bond pads may serve as alignment features, for example when designed to correspond to compatible alignment features fabricated on the receiving chip.

As shown in FIG. 13B, a PRC configured for evanescent coupling may include a bond pad that aligns to a visual alignment feature on the receiving chip. FIG. 13C depicts a PRC configured for endfire coupling with a bond pad that latches into an etched socket to ensure alignment and to lock the PRC in place. FIG. 13D shows the evanescently coupled PRC bond pad positioned on top of the alignment feature, while FIG. 13E shows the endfire-coupled PRC bond pad positioned within the etched socket. In FIG. 13E, light is transmitted from a PRC waveguide to a receiving chip waveguide. FIG. 13F shows an image of a bond pad design, which may include holes to accommodate release or undercut processes. In some implementations, breakable tethers may be used to keep the bond pad secured in place until it is ready to be transferred and bonded.

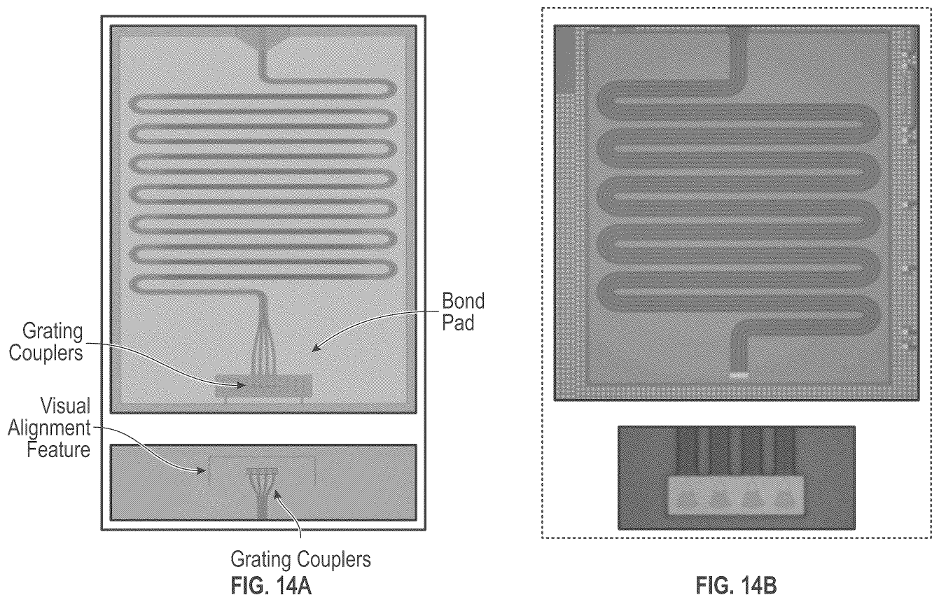

FIGS. 14A and 14B depict embodiments in which PRCs include grating couplers at one or both ends to provide optical coupling. In some implementations, tethered grating couplers at the end of a PRC may be used for optical sensing and/or for coupling to components on a target chip. As shown in FIG. 14A, a PRC may include grating couplers at one end that are configured to couple with compatible grating couplers on a receiving chip. The receiving chip may include a visual alignment feature associated with the PRC bond pad to assist with placement. As shown in FIG. 14B, a PRC with grating couplers at one end may further include a bottom metal reflector positioned beneath the grating region. Such a reflector may improve coupling efficiency by redirecting downward-radiated light upward into the grating, thereby increasing the overlap with the optical mode of the receiving chip. In some implementations, reflectors may also be positioned above the PRC grating couplers or beneath the receiving chip grating couplers to further enhance efficiency.

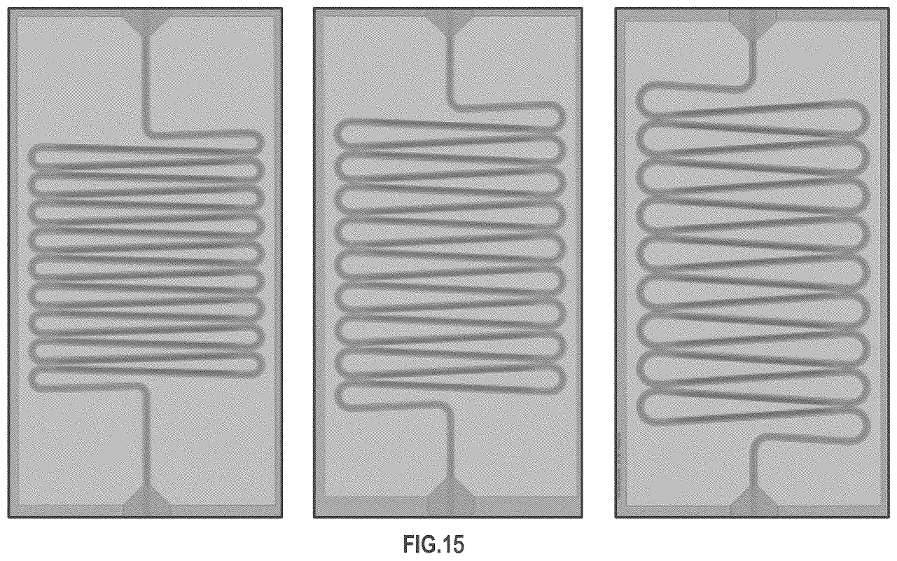

FIG. 15 depicts embodiments of PRCs fabricated with accordion-style meandering lengths that include bend angles larger than 90° and larger than 180°. In contrast to the previously described accordion geometries, which included 90° and 180° turns, the devices shown in FIG. 15 employ larger bend angles to achieve a more compact overall footprint for the ribbon cable. Three exemplary PRCs are depicted side-by-side in FIG. 15, each having a different bend radius, with the bend radius increasing from left to right. By increasing the bend angle and tuning the bend radius, the accordion meander may occupy less area on the fabrication substrate while still permitting in-plane extension and maintaining low optical loss.

### EXEMPLARY EMBODIMENTS

Embodiment 1. A photonic ribbon cable comprising:
   a waveguide having a winding geometry that enables the waveguide to deform such that a first end of the waveguide extends away from a second end of the waveguide.
Embodiment 2. The photonic ribbon cable of embodiment 1, wherein the photonic ribbon cable was manufactured using a semiconductor device fabrication process.
Embodiment 3. The photonic ribbon cable of embodiment 1, wherein the first end of the waveguide is extendable away from the second end of the waveguide within a first plane.
Embodiment 4. The photonic ribbon cable of embodiment 1, wherein the first end of the waveguide is extendable from a first plane containing the second end of the waveguide into a second plane that is different from the first plane.
Embodiment 5. The photonic ribbon cable of embodiment 1, wherein the waveguide comprises a plurality of bends.
Embodiment 6. The photonic ribbon cable of embodiment 5, wherein the plurality of bends comprises at least one bend with a horseshoe shape.
Embodiment 7. The photonic ribbon cable of embodiment 5, further comprising one or more tethers formed at one or more of the plurality of bends, wherein the one or more tethers are configured to constrain movement of the photonic ribbon cable prior to extension.
Embodiment 8. The photonic ribbon cable of embodiment 5, wherein the waveguide is deformable from a first unextended position to a second extended position;
   in the first unextended position, a bend of the plurality of bends has a first radius of curvature; and
   in the second extended position, the bend of the plurality of bends has a second radius of curvature greater than the first radius of curvature.
Embodiment 9. The photonic ribbon cable of embodiment 5, wherein the plurality of bends form concentric spirals.
Embodiment 10. The photonic ribbon cable of embodiment 5, wherein the waveguide comprises a plurality of linear segments of the same length connected by the plurality of bends.
Embodiment 11. The photonic ribbon cable of embodiment 10, wherein the waveguide is deformable from a first unextended position to a second extended position;
   the waveguide has a rectangular cross section;
   in the first unextended position, the plurality of bends and the plurality of linear segments have a zero-roll flat orientation with respect to a direction of propagation of light within the waveguide; and
   in the second extended position, a bend of the plurality of bends has a non-zero-roll banked orientation and a linear segment of the plurality of linear segments has a twisting-roll orientation.
Embodiment 12. The photonic ribbon cable of embodiment 1, wherein the first end of the waveguide comprises a bond pad.
Embodiment 13. The photonic ribbon cable of embodiment 1, wherein the second end of the waveguide comprises a bond pad.
Embodiment 14. The photonic ribbon cable of embodiment 1, further comprising a cladding material that encases the waveguide.
Embodiment 15. The photonic ribbon cable of embodiment 14, wherein the waveguide comprises silicon and the cladding comprises silicon dioxide.
Embodiment 16. The photonic ribbon cable of embodiment 14, wherein the waveguide comprises silicon nitride and the cladding comprises silicon dioxide.
Embodiment 17. The photonic ribbon cable of embodiment 1, wherein the waveguide comprises two or more waveguide channels.
Embodiment 18. The photonic ribbon cable of embodiment 17, wherein different waveguide channels of the two or more waveguide channels are configured to transmit different optical wavelengths.
Embodiment 19. The photonic ribbon cable of embodiment 17, wherein at least two of the two or more waveguide channels comprise different cross-sectional widths.
Embodiment 20. The photonic ribbon cable of embodiment 1, wherein one or more bond pads, at one or both of the first end of the waveguide and the second end of the waveguide, comprise one or more alignment features.
Embodiment 21. The photonic ribbon cable of embodiment 1, wherein the waveguide comprises a taper region configured to adiabatically couple light between the waveguide and a target photonic component.
Embodiment 22. The photonic ribbon cable of embodiment 21, wherein the taper region is configured to enlarge an optical mode of light within the waveguide.
Embodiment 23. The photonic ribbon cable of embodiment 1, wherein at least one end of the waveguide terminates in a grating coupler configured to couple to a target photonic component.
Embodiment 24. The photonic ribbon cable of embodiment 23, wherein at least one reflector, configured to improve coupling efficiency, is positioned above or below the grating coupler.
Embodiment 25. The photonic ribbon cable of embodiment 1, further comprising: an electrical conductor, wherein the electrical conductor is layered with the waveguide and has the same winding geometry as the waveguide, wherein the winding geometry enables a first end of the electrical conductor to be extended away from a second end of the electrical conductor.
Embodiment 26. The photonic ribbon cable of embodiment 25, wherein the electrical conductor comprises one or more metal layers within a cladding material and is configured to provide electrical interconnects between the photonic ribbon cable and one or more external electronic components.
Embodiment 27. The photonic ribbon cable of embodiment 1, further comprising at least one piezoelectric layer within a cladding material, the piezoelectric layer configured to actuate mechanical deformation of the photonic ribbon cable.
Embodiment 28. A photonic system comprising:
   a first photonic component;
   a second photonic component; and
   a photonic ribbon cable comprising a waveguide extending from a first end of the photonic ribbon cable to a second end of the photonic ribbon cable and having a winding geometry that enables the first end of the photonic ribbon cable to be extended away from the second end of the photonic ribbon cable,
   wherein the first end of the photonic ribbon cable is optically coupled to the first photonic component and the second end of the waveguide is optically coupled to the second photonic component.
Embodiment 29. The photonic system of embodiment 28, wherein the first photonic component and the second photonic component are positioned in the same plane.
Embodiment 30. The photonic system of embodiment 28, wherein the first photonic component is positioned in a first plane and the second photonic component is positioned in a second plane different from the first plane.
Embodiment 31. The photonic system of embodiment 28, wherein the first photonic component is a component of a first chip and the second photonic component is a component of a second chip.
Embodiment 32. The photonic system of embodiment 31, wherein the first chip and the second chip were formed by cleaving a third chip in two.
Embodiment 33. The photonic system of embodiment 32, wherein the photonic ribbon cable was fabricated on the third chip using a semiconductor device fabrication process, wherein, during fabrication, a medial portion of the waveguide between the first end of the waveguide and the second end of the waveguide was released from the third chip.
Embodiment 34. The photonic system of embodiment 31, wherein the photonic ribbon cable was fabricated on the first chip using a semiconductor device fabrication process, wherein, during fabrication, the second end of the waveguide was released from the first chip.
Embodiment 35. The photonic system of embodiment 28, wherein a separation distance between the first photonic component and the second photonic component is at least 10 cm.
Embodiment 36. The photonic system of embodiment 35, wherein the separation distance is at least 1 m.
Embodiment 37. The photonic system of embodiment 28, wherein the first photonic component is located in a cryogenic environment and the second photonic component is located in a room temperature environment.
Embodiment 38. The photonic system of embodiment 28, wherein the first photonic component is optically sensitive and the second photonic component is optically noisy.
Embodiment 39. The photonic system of embodiment 28, wherein the system is a quantum computing system.
Embodiment 40. A method for optically interconnecting photonic devices, the method comprising:
   forming a waveguide on a chip, the waveguide having a winding geometry;
   undercutting at least a portion of the waveguide by removing a sacrificial material underlying the at least a portion of the waveguide; and
   optically coupling a first photonic component to a second photonic component using the waveguide, wherein optically coupling the first photonic component to the second photonic component comprises moving ends of the waveguide away from each other.
Embodiment 41. The method of embodiment 40, wherein the first photonic component and the second photonic component are components of the chip, wherein moving the ends of the waveguide away from each other comprises:
   cleaving the chip without cleaving the waveguide to form a first chip comprising the first photonic component and a second chip comprising the second photonic component, wherein the waveguide bridges the first chip and the second chip.
Embodiment 42. The method of embodiment 40, wherein the chip is a first chip, wherein the first photonic component is a component of the first chip, wherein the second photonic component is a component of a second chip, wherein optically coupling the first photonic component to the second photonic component comprises:
   lifting a first end of the waveguide from the first chip; and
   placing the first end of the waveguide on the second chip.
Embodiment 43. The method of embodiment 40, wherein undercutting the at least a portion of the waveguide comprises undercutting the entire waveguide.
Embodiment 44. The method of embodiment 43, wherein the chip is a first chip, wherein the first photonic component is a component of a second chip, wherein the second photonic component is a component of a third chip, wherein optically coupling the first photonic component to the second photonic component comprises:
   lifting the waveguide from the first chip;
   placing a first end of the waveguide on the second chip; and placing a second end of the waveguide on the third chip.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A photonic ribbon cable comprising:
a waveguide having a winding geometry that enables the waveguide to deform such that a first end of the waveguide extends away from a second end of the waveguide.

2. The photonic ribbon cable of claim 1, wherein the photonic ribbon cable was manufactured using a semiconductor device fabrication process.

3. The photonic ribbon cable of claim 1, wherein the first end of the waveguide is extendable away from the second end of the waveguide within a first plane.

4. The photonic ribbon cable of claim 1, wherein the first end of the waveguide is extendable from a first plane containing the second end of the waveguide into a second plane that is different from the first plane.

5. The photonic ribbon cable of claim 1, wherein the waveguide comprises a plurality of bends.

6. The photonic ribbon cable of claim 5, wherein the plurality of bends comprises at least one bend with a horseshoe shape.

7. The photonic ribbon cable of claim 5, further comprising one or more tethers formed at one or more of the plurality of bends, wherein the one or more tethers are configured to constrain movement of the photonic ribbon cable prior to extension.

8. The photonic ribbon cable of claim 5, wherein the waveguide is deformable from a first unextended position to a second extended position;
in the first unextended position, a bend of the plurality of bends has a first radius of curvature; and
in the second extended position, the bend of the plurality of bends has a second radius of curvature greater than the first radius of curvature.

9. The photonic ribbon cable of claim 5, wherein the plurality of bends form concentric spirals.

10. The photonic ribbon cable of claim 5, wherein the waveguide comprises a plurality of linear segments of the same length connected by the plurality of bends.

11. The photonic ribbon cable of claim 10, wherein the waveguide is deformable from a first unextended position to a second extended position;
the waveguide has a rectangular cross section;
in the first unextended position, the plurality of bends and the plurality of linear segments have a zero-roll flat orientation with respect to a direction of propagation of light within the waveguide; and
in the second extended position, a bend of the plurality of bends has a non-zero-roll banked orientation and a linear segment of the plurality of linear segments has a twisting-roll orientation.

12. The photonic ribbon cable of claim 1, wherein the first end of the waveguide comprises a first bond pad and the second end of the waveguide comprises a second bond pad.

13. The photonic ribbon cable of claim 1, further comprising a cladding material that encases the waveguide.

14. The photonic ribbon cable of claim 13, wherein the waveguide comprises silicon or silicon nitride and the cladding comprises silicon dioxide.

15. The photonic ribbon cable of claim 1, wherein the waveguide comprises two or more waveguide channels.

16. The photonic ribbon cable of claim 15, wherein different waveguide channels of the two or more waveguide channels are configured to transmit different optical wavelengths.

17. The photonic ribbon cable of claim 15, wherein at least two of the two or more waveguide channels comprise different cross-sectional widths.

18. The photonic ribbon cable of claim 1, wherein one or more bond pads, at one or both of the first end of the waveguide and the second end of the waveguide, comprise one or more alignment features.

19. The photonic ribbon cable of claim 1, wherein the waveguide comprises a taper region configured to:
adiabatically couple light between the waveguide and a target photonic component; and
enlarge an optical mode of light within the waveguide.

20. The photonic ribbon cable of claim 1, wherein the waveguide comprises a region configured to evanescently couple light between the waveguide and a target photonic component.

21. The photonic ribbon cable of claim 1, wherein the waveguide comprises a region configured to couple light directly between a facet of the waveguide and a facet of a waveguide of a target photonic component.

22. The photonic ribbon cable of claim 1, wherein at least one end of the waveguide terminates in a grating coupler configured to couple to a target photonic component.

23. The photonic ribbon cable of claim 1, further comprising:
an electrical conductor, wherein the electrical conductor is layered with the waveguide and has the same winding geometry as the waveguide, wherein the winding geometry enables a first end of the electrical conductor to be extended away from a second end of the electrical conductor.

24. The photonic ribbon cable of claim 23, wherein the electrical conductor comprises one or more metal layers within a cladding material and is configured to provide electrical interconnects between the photonic ribbon cable and one or more external electronic components.

25. The photonic ribbon cable of claim 24, further comprising at least one piezoelectric layer within a cladding material, wherein:
the at least one piezoelectric layer is configured to actuate mechanical deformation of the photonic ribbon cable,
the electrical conductor comprises a plurality of metal layers, and
the at least one piezoelectric layer is disposed between the plurality of metal layers.
